(19) United States
(12) Patent Application Publication
(10) Pub. No.: US 2026/0254845 A1
(43) Pub. Date: Aug. 27, 2026

(54) SYSTEMS AND METHODS FOR EFFICIENTLY REMEDIATING COMPUTING ENVIRONMENTS FROM CYBERSECURITY RISKS

(71) Applicant: Tenable, Inc., Columbia, MD (US)

(72) Inventors: Slawomir GRZONKOWSKI, Dublin (IE); Itamar MIZRAHI, Tel Aviv (IL)

(21) Appl. No.: 19/065,316

(22) Filed: Feb. 27, 2025

(51) Int. Cl. H04L 9/40

(52) U.S. Cl. CPC H04L 63/1441; H04L 63/1433

(57) ABSTRACT

In some aspects, a device may determine a plurality of attack paths from a first set of assets to a second set of assets. The device may determine a plurality of asset remediation priorities based on an association between each of the assets and one or more of the attack paths. The device may perform one or more remediation-related actions associated with one or more of the assets based on the asset remediation priorities.

### BACKGROUND OF THE DISCLOSURE

### 1. Field of the Disclosure

Aspects relate to systems and methods for remediating vulnerabilities in computing environments.

### 2. Description of the Related Art

In modern computer networks, first-line cybersecurity responders are often overwhelmed by the sheer volume of tasks generated by the users that they manage. Unfortunately, as organizations grow in size, this workload will only increase due to new threats that require additional products or services to address them. Meanwhile, the number of employees within a given organization may often expand beyond manageable levels.

This situation may necessitate prioritization of threats in order for cybersecurity responders to work effectively and efficiently to protect the organization. Despite these efforts, however, the volume of required work often remains beyond manageable levels.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method includes determining a plurality of attack paths from a first set of assets to a second set of assets; determining a plurality of asset remediation priorities based on an association between each of the assets and one or more of the attack paths; and performing one or more remediation-related actions associated with one or more of the assets based on the asset remediation priorities.

In some aspects, a device includes one or more memories; and one or more processors communicatively coupled to the one or more memories, the one or more processors, either alone or in combination, configured to: determine a plurality of attack paths from a first set of assets to a second set of assets; determine a plurality of asset remediation priorities based on an association between each of the assets and one or more of the attack paths; and perform one or more remediation-related actions associated with one or more of the assets based on the asset remediation priorities.

In some aspects, a non-transitory computer-readable medium stores computer-executable instructions that, when executed by a device, cause the device to: determine a plurality of attack paths from a first set of assets to a second set of assets; determine a plurality of asset remediation priorities based on an association between each of the assets and one or more of the attack paths; and perform one or more remediation-related actions associated with one or more of the assets based on the asset remediation priorities.

Other objects and advantages associated with the aspects disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary network having various assets that can be managed using a vulnerability management system, according to various aspects.

FIG. 2 illustrates another exemplary network having various assets that can be managed using a vulnerability management system, according to various aspects.

FIG. 3 illustrates a diagram of an example system suitable for interactive remediation of vulnerabilities of web applications based on scanning of web applications.

FIG. 4 illustrates a server, according to aspects of the disclosure.

FIG. 5 generally illustrates a user equipment (UE) in accordance with aspects of the disclosure.

FIG. 6 illustrates an example neural network, according to aspects of the disclosure.

FIG. 7 illustrates cloud network architecture, in accordance with aspects of the disclosure.

FIG. 8 illustrates a process, in accordance with aspects of the disclosure.

FIG. 9 illustrates an example of a graph representing a customer computing environment, according to aspects of the disclosure.

FIG. 10 illustrates an example of a graph representing a customer computing environment in which each customer asset is assigned an asset criticality rating (ACR), according to aspects of the disclosure.

FIG. 11 illustrates an example of a graph representing a customer computing environment in which the critical assets are labeled crown jewels, according to aspects of the disclosure.

FIG. 12 illustrates an example of a graph representing a customer computing environment with a plurality of attack paths leading to the critical assets, according to aspects of the disclosure.

FIG. 13 illustrates an example of a graph representing a customer computing environment in which the critical assets are assigned a priority score indicating the highest level of priority, according to aspects of the disclosure.

FIG. 14 illustrates an example of a graph representing a customer computing environment in which assets at choke points of attack paths are assigned a priority score, according to aspects of the disclosure.

FIG. 15 illustrates an example of a graph representing a customer computing environment in which assets having direct attack paths to the critical assets are assigned a priority score, according to aspects of the disclosure.

FIG. 16 illustrates an example of a graph representing a customer computing environment in which assets having relatively short paths to the critical assets are assigned a priority score, according to aspects of the disclosure.

FIG. 17 illustrates an example of a graph representing a customer computing environment in which assets having a relatively high ACR are assigned a priority score, according to aspects of the disclosure.

FIG. 18 illustrates an example of a graph representing a customer computing environment in which assets on any of the attack paths are assigned a priority score, according to aspects of the disclosure.

FIG. 19 illustrates an example of a graph representing a customer computing environment in which assets that are not on any of the attack paths are assigned a priority score, according to aspects of the disclosure.

FIG. 20 illustrates an example of a computing graph that includes paths, nodes and their corresponding detections, according to aspects of the disclosure.

The accompanying drawings are presented to aid in the description of various aspects of the disclosure and are provided solely for illustration of the aspects and not limitation thereof.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the term “asset” and variants thereof may generally refer to any suitable uniquely defined electronic object that has been identified via one or more preferably unique but possibly non-unique identifiers or identification attributes (e.g., a universally unique identifier (UUID), a Media Access Control (MAC) address, a Network BIOS (NetBIOS) name, a Fully Qualified Domain Name (FQDN), an Internet Protocol (IP) address, a tag, a CPU ID, an instance ID, a Secure Shell (SSH) key, a user-specified identifier such as a registry setting, file content, information contained in a record imported from a configuration management database (CMDB), etc.). For example, the various aspects and embodiments described herein contemplate that an asset may be a physical electronic object such as, without limitation, a desktop computer, a laptop computer, a server, a storage device, a network device, a phone, a tablet, a wearable device, an Internet of Things (IoT) device, a set-top box or media player, etc. Furthermore, the various aspects and embodiments described herein contemplate that an asset may be a virtual electronic object such as, without limitation, a cloud instance, a virtual machine instance, a container, etc., a web application that can be addressed via a Uniform Resource Identifier (URI) or Uniform Resource Locator (URL), and/or any suitable combination thereof. Those skilled in the art will appreciate that the above-mentioned examples are not intended to be limiting but instead are intended to illustrate the ever-evolving types of resources that can be present in a modern computer network. As such, the various aspects and embodiments to be described in further detail below may include various techniques to manage network vulnerabilities according to an asset-based (rather than host-based) approach, whereby the various aspects and embodiments described herein contemplate that a particular asset can have multiple unique identifiers (e.g., a UUID and a MAC address) and that a particular asset can have multiples of a given unique identifier (e.g., a device with multiple network interface cards (NICs) may have multiple unique MAC addresses). Furthermore, as will be described in further detail below, the various aspects and embodiments described herein contemplate that a particular asset can have one or more dynamic identifiers that can change over time (e.g., an IP address) and that different assets may share a non-unique identifier (e.g., an IP address can be assigned to a first asset at a first time and assigned to a second asset at a second time). Accordingly, the identifiers or identification attributes used to define a given asset may vary with respect to uniqueness and the probability of multiple occurrences, which may be taken into consideration in reconciling the particular asset to which a given data item refers. Furthermore, in the elastic licensing model described herein, an asset may be counted as a single unit of measurement for licensing purposes. Further, assets may encompass tangential network aspects such as policies, rules and so forth.

Assets may also be implemented within or as part of cloud network architecture (e.g., cloud assets may correspond to instances or virtual machines (VMs), particular devices or groups of devices, distributed resources across multiple devices and/or locations, etc.) By way of examples, cloud assets may include, but are not limited to, any of the following examples which are characterized with respect to AMAZON, GOOGLE and MICROSOFT cloud services (e.g., Amazin Web Services, Microsoft Azure, Google Cloud), e.g.:
‘aws_athena_database’
‘aws_db_instance’
‘aws_db_snapshot’
‘aws_dynamodb_table’
‘aws_ecr_repository’
‘aws_ecr_repository_policy’
‘aws_ecs_cluster’
‘aws_ecs_service’
‘aws_eks_cluster’
‘aws_elb’
‘aws_emr_cluster’
‘aws_instance’
‘aws_nat_gateway’
‘aws_rds_cluster’
‘aws_rds_cluster_instance’
‘aws_redshift_cluster’
‘aws_s3_bucket’
‘aws_s3_bucket_policy’
‘azurerm_container_group’
‘azurerm_container_registry’
‘azurerm_kubernetes_cluster’
‘azurerm_lb’
‘azurerm_linux_virtual_machine’
‘azurerm_mariadb_server’
‘azurerm_mssql_server’
‘azurerm_mssql_virtual_machine’
‘azurerm_mysql_database’
‘azurerm_mysql_server’
‘azurerm_postgresql_database’
‘azurerm_postgresql_server’
‘azurerm_sql_database’
‘azurerm_sql_server’
‘azurerm_storage_container’
‘azurerm_virtual_machine_scale_set’
‘azurerm_windows_virtual_machine’
‘google_bigquery_dataset’
‘google_bigquery_table’
‘google_compute_forwarding_rule’
‘google_compute_global_forwarding_rule’
‘google_compute_instance’
‘google_container_cluster’
‘google_container_registry’
‘google_sql_database’
‘google_sql_database_instance’
‘google_storage_bucket’
‘kubernetes_cluster’
‘kubernetes_pod’

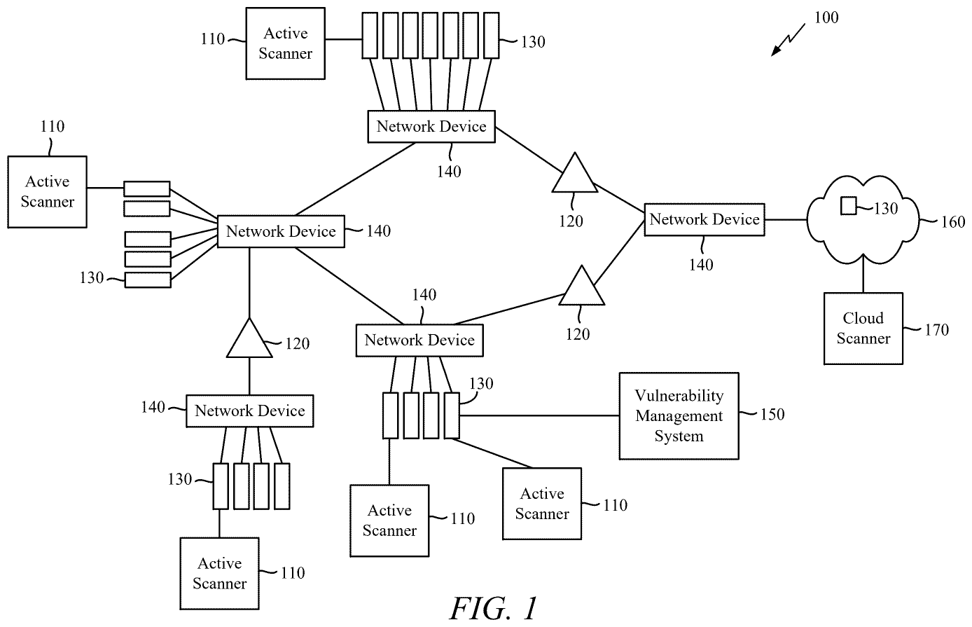

According to various aspects, FIG. 1 illustrates an exemplary network 100 having various assets 130 that are interconnected via one or more network devices 140 and managed using a vulnerability management system 150. More particularly, as noted above, the assets 130 may include various types, including traditional assets (e.g., physical desktop computers, servers, storage devices, etc.), web applications that run self-supporting code, Internet of Things (IoT) devices (e.g., consumer appliances, conference room utilities, cars parked in office lots, physical security systems, etc.), mobile or bring-your-own-device (BYOD) resources (e.g., laptop computers, mobile phones, tablets, wearables, etc.), virtual objects (e.g., containers and/or virtual machine instances that are hosted within the network 100, cloud instances hosted in off-site server environments, etc.). Those skilled in the art will appreciate that the assets 130 listed above are intended to be exemplary only and that the assets 130 associated with the network 100 may include any suitable combination of the above-listed asset types and/or other suitable asset types. Furthermore, in various embodiments, the one or more network devices 140 may include wired and/or wireless access points, small cell base stations, network routers, hubs, spanned switch ports, network taps, choke points, and so on, wherein the network devices 140 may also be included among the assets 130 despite being labelled with a different reference numeral in FIG. 1.

According to various aspects, the assets 130 that make up the network 100 (including the network devices 140 and any assets 130 such as cloud instances that are hosted in an off-site server environment or other remote network 160) may collectively form an attack surface that represents the sum total of resources through which the network 100 may be vulnerable to a cyberattack. As will be apparent to those skilled in the art, the diverse nature of the various assets 130 make the network 100 substantially dynamic and without clear boundaries, whereby the attack surface may expand and contract over time in an often unpredictable manner thanks to trends like BYOD and DevOps, thus creating security coverage gaps and leaving the network 100 vulnerable. For example, due at least in part to exposure to the interconnectedness of new types of assets 130 and abundant software changes and updates, traditional assets like physical desktop computers, servers, storage devices, and so on are more exposed to security vulnerabilities than ever before. Moreover, vulnerabilities have become more and more common in self-supported code like web applications as organizations seek new and innovative ways to improve operations. Although delivering custom applications to employees, customers, and partners can increase revenue, strengthen customer relationships, and improve efficiency, these custom applications may have flaws in the underlying code that could expose the network 100 to an attack. In other examples, IoT devices are growing in popularity and address modern needs for connectivity but can also add scale and complexity to the network 100, which may lead to security vulnerabilities as IoT devices are often designed without security in mind. Furthermore, trends like mobility, BYOD, etc. mean that more and more users and devices may have access to the network 100, whereby the idea of a static network with devices that can be tightly controlled is long gone. Further still, as organizations adopt DevOps practices to deliver applications and services faster, there is a shift in how software is built and short-lived asses like containers and virtual machine instances are used. While these types of virtual assets can help organizations increase agility, they also create significant new exposure for security teams. Even the traditional idea of a perimeter for the network 100 is outdated, as many organizations are connected to cloud instances that are hosted in off-site server environments, increasing the difficulty to accurately assess vulnerabilities, exposure, and overall risk from cyberattacks that are also becoming more sophisticated, more prevalent, and more likely to cause substantial damage.

Accordingly, to address the various security challenges that may arise due to the network 100 having an attack surface that is substantially elastic, dynamic, and without boundaries, the vulnerability management system 150 may include various components that are configured to help detect and remediate vulnerabilities in the network 100.

More particularly, the network 100 may include one or more active scanners 110 configured to communicate packets or other messages within the network 100 to detect new or changed information describing the various network devices 140 and other assets 130 in the network 100. For example, in one implementation, the active scanners 110 may perform credentialed audits or uncredentialed scans to scan certain assets 130 in the network 100 and obtain information that may then be analyzed to identify potential vulnerabilities in the network 100. As used herein “credentialed” scans rely upon user credential(s) for authentication. Credentialed scans can perform a wider variety of checks than non-credentialed scans, which can result in more accurate scan results. Non-credentialed scans by contrast do not rely upon user credential(s) for authentication. More particularly, in one implementation, the credentialed audits may include the active scanners 110 using suitable authentication technologies to log into and obtain local access to the assets 130 in the network 100 and perform any suitable operation that a local user could perform thereon without necessarily requiring a local agent. Alternatively and/or additionally, the active scanners 110 may include one or more agents (e.g., lightweight programs) locally installed on a suitable asset 130 and given sufficient privileges to collect vulnerability, compliance, and system data to be reported back to the vulnerability management system 150. As such, the credentialed audits performed with the active scanners 110 may generally be used to obtain highly accurate host-based data that includes various client-side issues (e.g., missing patches, operating system settings, locally running services, etc.). On the other hand, the uncredentialed audits may generally include network-based scans that involve communicating packets or messages to the appropriate asset(s) 130 and observing responses thereto in order to identify certain vulnerabilities (e.g., that a particular asset 130 accepts spoofed packets that may expose a vulnerability that can be exploited to close established connections). Furthermore, as shown in FIG. 1, one or more cloud scanners 170 may be configured to perform a substantially similar function as the active scanners 110, except that the cloud scanners 170 may also have the ability to scan assets 130 like cloud instances that are hosted in a remote network 160 (e.g., an off-site server environment or other suitable cloud infrastructure).

Additionally, in various implementations, one or more passive scanners 120 may be deployed within the network 100 to observe or otherwise listen to traffic in the network 100, to identify further potential vulnerabilities in the network 100, and to detect activity that may be targeting or otherwise attempting to exploit previously identified vulnerabilities. In one implementation, as noted above, the active scanners 110 may obtain local access to one or more of the assets 130 in the network 100 (e.g., in a credentialed audit) and/or communicate various packets or other messages within the network 100 to illicit responses from one or more of the assets 130 (e.g., in an uncredentialed scan). In contrast, the passive scanners 120 may generally observe (or “sniff”) various packets or other messages in the traffic traversing the network 100 to passively scan the network 100. In particular, the passive scanners 120 may reconstruct one or more sessions in the network 100 from information contained in the sniffed traffic, wherein the reconstructed sessions may then be used in combination with the information obtained with the active scanners 110 to build a model or topology describing the network 100. For example, in one implementation, the model or topology built from the information obtained with the active scanners 110 and the passive scanners 120 may describe any network devices 140 and/or other assets 130 that are detected or actively running in the network 100, any services or client-side software actively running or supported on the network devices 140 and/or other assets 130, and trust relationships associated with the various network devices 140 and/or other assets 130, among other things. In one implementation, the passive scanners 120 may further apply various signatures to the information in the observed traffic to identify vulnerabilities in the network 100 and determine whether any data in the observed traffic potentially targets such vulnerabilities. In one implementation, the passive scanners 120 may observe the network traffic continuously, at periodic intervals, on a pre-configured schedule, or in response to determining that certain criteria or conditions have been satisfied. The passive scanners 120 may then automatically reconstruct the network sessions, build or update the network model, identify the network vulnerabilities, and detect the traffic potentially targeting the network vulnerabilities in response to new or changed information in the network 100.

In one implementation, as noted above, the passive scanners 120 may generally observe the traffic traveling across the network 100 to reconstruct one or more sessions occurring in the network 100, which may then be analyzed to identify potential vulnerabilities in the network 100 and/or activity targeting the identified vulnerabilities, including one or more of the reconstructed sessions that have interactive or encrypted characteristics (e.g., due to the sessions including packets that had certain sizes, frequencies, randomness, or other qualities that may indicate potential backdoors, covert channels, or other vulnerabilities in the network 100). Accordingly, the passive scanners 120 may monitor the network 100 in substantially real-time to detect any potential vulnerabilities in the network 100 in response to identifying interactive or encrypted sessions in the packet stream (e.g., interactive sessions may typically include activity occurring through keyboard inputs, while encrypted sessions may cause communications to appear random, which can obscure activity that installs backdoors or rootkit applications). Furthermore, in one implementation, the passive scanners 120 may identify changes in the network 100 from the encrypted and interactive sessions (e.g., an asset 130 corresponding to a new e-commerce server may be identified in response to the passive scanners 120 observing an encrypted and/or interactive session between a certain host located in the remote network 160 and a certain port that processes electronic transactions). In one implementation, the passive scanners 120 may observe as many sessions in the network 100 as possible to provide optimal visibility into the network 100 and the activity that occurs therein. For example, in one implementation, the passive scanners 120 may be deployed at any suitable location that enables the passive scanners 120 to observe traffic going into and/or out of one or more of the network devices 140. In one implementation, the passive scanners 120 may be deployed on any suitable asset 130 in the network 100 that runs a suitable operating system (e.g., a server, host, or other device that runs Red Hat Linux or FreeBSD open source operating system, a UNIX, Windows, or Mac OS X operating system, etc.).

Furthermore, in one implementation, the various assets and vulnerabilities in the network 100 may be managed using the vulnerability management system 150, which may provide a unified security monitoring solution to manage the vulnerabilities and the various assets 130 that make up the network 100. In particular, the vulnerability management system 150 may aggregate the information obtained from the active scanners 110 and the passive scanners 120 to build or update the model or topology associated with the network 100, which may generally include real-time information describing various vulnerabilities, applied or missing patches, intrusion events, anomalies, event logs, file integrity audits, configuration audits, or any other information that may be relevant to managing the vulnerabilities and assets in the network 100. As such, the vulnerability management system 150 may provide a unified interface to mitigate and manage governance, risk, and compliance in the network 100.

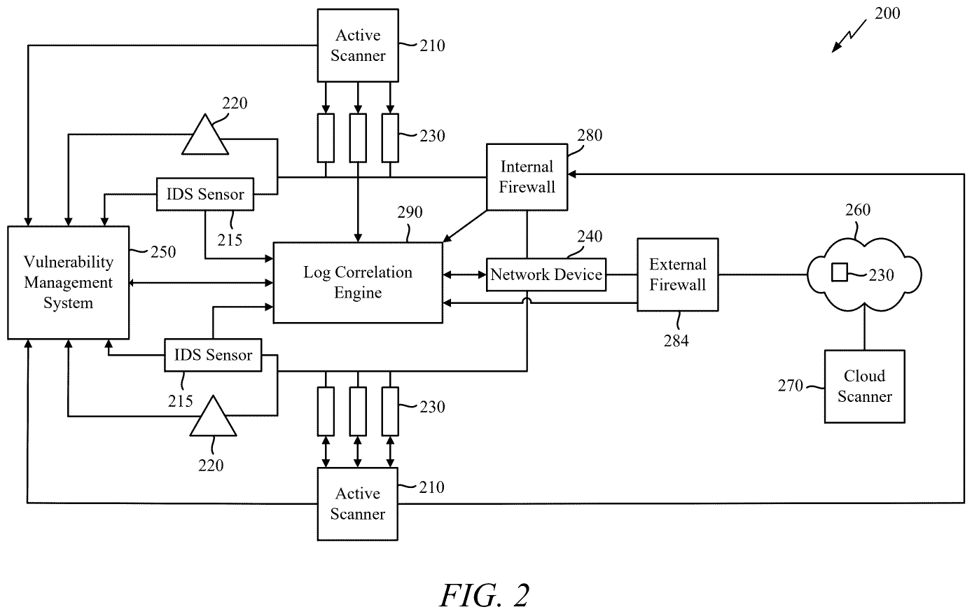

According to various aspects, FIG. 2 illustrates another exemplary network 200 with various assets 230 that can be managed using a vulnerability management system 250. In particular, the network 200 shown in FIG. 2 may have various components and perform substantially similar functionality as described above with respect to the network 100 shown in FIG. 1. For example, in one implementation, the network 200 may include one or more active scanners 210 and/or cloud scanners 270, which may interrogate assets 230 in the network 200 to build a model or topology of the network 200 and identify various vulnerabilities in the network 200, one or more passive scanners 220 that can passively observe traffic in the network 200 to further build the model or topology of the network 200, identify further vulnerabilities in the network 200, and detect activity that may potentially target or otherwise exploit the vulnerabilities. Additionally, in one implementation, a log correlation engine 290 may be arranged to receive logs containing events from various sources distributed across the network 200. For example, in one implementation, the logs received at the log correlation engine 290 may be generated by internal firewalls 280, external firewalls 284, network devices 240, assets 230, operating systems, applications, or any other suitable resource in the network 200. Accordingly, in one implementation, the information obtained from the active scanners 210, the cloud scanners 270, the passive scanners 220, and the log correlation engine 290 may be provided to the vulnerability management system 250 to generate or update a comprehensive model associated with the network 200 (e.g., topologies, vulnerabilities, assets, etc.).

In one implementation, the active scanners 210 may be strategically distributed in locations across the network 200 to reduce stress on the network 200. For example, the active scanners 210 may be distributed at different locations in the network 200 in order to scan certain portions of the network 200 in parallel, whereby an amount of time to perform the active scans may be reduced. Furthermore, in one implementation, one or more of the active scanners 210 may be distributed at a location that provides visibility into portions of a remote network 260 and/or offloads scanning functionality from the managed network 200. For example, as shown in FIG. 2, one or more cloud scanners 270 may be distributed at a location in communication with the remote network 260, wherein the term “remote network” as used herein may refer to the Internet, a partner network, a wide area network, a cloud infrastructure, and/or any other suitable external network. As such, the terms “remote network,” “external network,” “partner network,” and “Internet” may all be used interchangeably to suitably refer to one or more networks other than the networks 100, 200 that are managed using the vulnerability management systems 150, 250, while references to “the network” and/or “the internal network” may generally refer to the areas that the systems and methods described herein may be used to protect or otherwise manage. Accordingly, in one implementation, limiting the portions in the managed network 200 and/or the remote network 260 that the active scanners 210 are configured to interrogate, probe, or otherwise scan and having the active scanners 210 perform the scans in parallel may reduce the amount of time that the active scans consume because the active scanners 210 can be distributed closer to scanning targets. In particular, because the active scanners 210 may scan limited portions of the network 200 and/or offload scanning responsibility to the cloud scanners 270, and because the parallel active scans may obtain information from the different portions of the network 200, the overall amount of time that the active scans consume may substantially correspond to the amount of time associated with one active scan.

As such, in one implementation, the active scanners 210 and/or cloud scanners 270 may generally scan the respective portions of the network 200 to obtain information describing vulnerabilities and assets in the respective portions of the network 200. In particular, the active scanners 210 and/or cloud scanners 270 may perform the credentialed and/or uncredentialed scans in the network in a scheduled or distributed manner to perform patch audits, web application tests, operating system configuration audits, database configuration audits, sensitive file or content searches, or other active probes to obtain information describing the network. For example, the active scanners 210 and/or cloud scanners 270 may conduct the active probes to obtain a snapshot that describes assets actively running in the network 200 at a particular point in time (e.g., actively running network devices 240, internal firewalls 280, external firewalls 284, and/or other assets 230). In various embodiments, the snapshot may further include any exposures that the actively running assets to vulnerabilities identified in the network 200 (e.g., sensitive data that the assets contain, intrusion events, anomalies, or access control violations associated with the assets, etc.), configurations for the actively running assets (e.g., operating systems that the assets run, whether passwords for users associated with the assets comply with certain policies, whether assets that contain sensitive data such as credit card information comply with the policies and/or industry best practices, etc.), or any other information suitably describing vulnerabilities and assets actively detected in the network 200. In one implementation, in response to obtaining the snapshot of the network 200, the active scanners 210 and/or cloud scanners 270 may then report the information describing the snapshot to the vulnerability management system 250, which may use the information provided by the active scanners 210 to remediate and otherwise manage the vulnerabilities and assets in the network.

Furthermore, in one implementation, the passive scanners 220 may be distributed at various locations in the network 200 to monitor traffic traveling across the network 200, traffic originating within the network 200 and directed to the remote network 260, and traffic originating from the remote network 260 and directed to the network 200, thereby supplementing the information obtained with the active scanners 210. For example, in one implementation, the passive scanners 220 may monitor the traffic traveling across the network 200 and the traffic originating from and/or directed to the remote network 260 to identify vulnerabilities, assets, or information that the active scanners 210 may be unable to obtain because the traffic may be associated with previously inactive assets that later participate in sessions on the network. Additionally, in one implementation, the passive scanners 220 may be deployed directly within or adjacent to an intrusion detection system sensor 215, which may provide the passive scanners 220 with visibility relating to intrusion events or other security exceptions that the intrusion detection system (IDS) sensor 215 identifies. In one implementation, the IDS may be an open source network intrusion prevention and detection system (e.g., Snort), a packet analyzer, or any other system that having a suitable IDS sensor 215 that can detect and prevent intrusion or other security events in the network 200.

Accordingly, in various embodiments, the passive scanners 220 may sniff one or more packets or other messages in the traffic traveling across, originating from, or directed to the network 200 to identify new network devices 240, internal firewalls 280, external firewalls 284, or other assets 230 in addition to open ports, client/server applications, any vulnerabilities, or other activity associated therewith. In addition, the passive scanners 220 may further monitor the packets in the traffic to obtain information describing activity associated with web sessions, Domain Name System (DNS) sessions, Server Message Block (SMB) sessions, File Transfer Protocol (FTP) sessions, Network File System (NFS) sessions, file access events, file sharing events, or other suitable activity that occurs in the network 200. In one implementation, the information that the passive scanners 220 obtains from sniffing the traffic traveling across, originating from, or directed to the network 200 may therefore provide a real-time record describing the activity that occurs in the network 200. Accordingly, in one implementation, the passive scanners 220 may behave like a security motion detector on the network 200, mapping and monitoring any vulnerabilities, assets, services, applications, sensitive data, and other information that newly appear or change in the network 200. The passive scanners 220 may then report the information obtained from the traffic monitored in the network to the vulnerability management system 250, which may use the information provided by the passive scanners 220 in combination with the information provided from the active scanners 210 to remediate and otherwise manage the network 200.

In one implementation, as noted above, the network 200 shown in FIG. 2 may further include a log correlation engine 290, which may receive logs containing one or more events from various sources distributed across the network 200 (e.g., logs describing activities that occur in the network 200, such as operating system events, file modification events, USB device insertion events, etc.). In particular, the logs received at the log correlation engine 290 may include events generated by one or more of the internal firewalls 280, external firewalls 284, network devices 240, and/or other assets 230 in the network 200 in addition to events generated by one or more operating systems, applications, and/or other suitable sources in the network 200. In one implementation, the log correlation engine 290 may normalize the events contained in the various logs received from the sources distributed across the network 200, and in one implementation, may further aggregate the normalized events with information describing the snapshot of the network 200 obtained by the active scanners 210 and/or the network traffic observed by the passive scanners 220. Accordingly, in one implementation, the log correlation engine 290 may analyze and correlate the events contained in the logs, the information describing the observed network traffic, and/or the information describing the snapshot of the network 200 to automatically detect statistical anomalies, correlate intrusion events or other events with the vulnerabilities and assets in the network 200, search the correlated event data for information meeting certain criteria, or otherwise manage vulnerabilities and assets in the network 200.

Furthermore, in one implementation, the log correlation engine 290 may filter the events contained in the logs, the information describing the observed network traffic, and/or the information describing the snapshot of the network 200 to limit the information that the log correlation engine 290 normalizes, analyzes, and correlates to information relevant to a certain security posture (e.g., rather than processing thousands or millions of events generated across the network 200, which could take a substantial amount of time, the log correlation engine 290 may identify subsets of the events that relate to particular intrusion events, attacker network addresses, assets having vulnerabilities that the intrusion events and/or the attacker network addresses target, etc.). Alternatively (or additionally), the log correlation engine 290 may persistently save the events contained in all of the logs to comply with regulatory requirements providing that all logs must be stored for a certain period of time (e.g., saving the events in all of the logs to comply with the regulatory requirements while only normalizing, analyzing, and correlating the events in a subset of the logs that relate to a certain security posture). As such, the log correlation engine 290 may aggregate, normalize, analyze, and correlate information received in various event logs, snapshots obtained by the active scanners 210 and/or cloud scanners 270, and/or the activity observed by the passive scanners 220 to comprehensively monitor, remediate, and otherwise manage the vulnerabilities and assets in the network 200. Additionally, in one implementation, the log correlation engine 290 may be configured to report information relating to the information received and analyzed therein to the vulnerability management system 250, which may use the information provided by the log correlation engine 290 in combination with the information provided by the passive scanners 220, the active scanners 210, and the cloud scanners 270 to remediate or manage the network 200.

Accordingly, in various embodiments, the active scanners 210 and/or cloud scanners 270 may interrogate any suitable asset 230 in the network 200 to obtain information describing a snapshot of the network 200 at any particular point in time, the passive scanners 220 may continuously or periodically observe traffic traveling in the network 200 to identify vulnerabilities, assets, or other information that further describes the network 200, and the log correlation engine 290 may collect additional information to further identify the vulnerabilities, assets, or other information describing the network 200. The vulnerability management system 250 may therefore provide a unified solution that aggregates vulnerability and asset information obtained by the active scanners 210, the cloud scanners 270, the passive scanners 220, and the log correlation engine 290 to comprehensively manage the network 200.

Security auditing applications typically display security issues (such as vulnerabilities, security misconfigurations, weaknesses, etc.) paired with a particular solution for that given issue. Certain security issues may share a given solution, or have solutions which are superseded or otherwise rendered unnecessary by other reported solutions. Embodiments of the disclosure relate to improving an efficiency by which security issues are reported, managed and/or rectified based on solution supersedence.

In accordance with a first embodiment, when working with security reporting datasets with sparse metadata available, the reported solutions for each security issue are combined, and various “rulesets” are applied against the combined solutions to de-duplicate them and remove solutions that have been superseded by other solutions. As used herein, a ruleset is a set of rules that govern when a solution is to be removed or merged with another and how that merge is to be accomplished. In an example, when solution texts not matching a given ruleset are discovered they are flagged for manual review. Examples of rules that may be included in one or more rulesets are as follows:
If there is more than one matching solution in the solution list, remove all but one of those solutions.
For solutions matching “Upgrade to <product> x.y.z” where x, y, and z are integers, select a single result with the highest x.y.z value (comparing against x first, then y, then z).
For solutions matching “Apply fix <fix> to <product>”, create a new combined solution where <fix> for each solution is concatenated into a comma separated list for a given <product>.

In accordance with a second embodiment, when working with datasets with metadata available that have an identifier that allows grouping of solutions based on product (e.g., common product enumeration (CPE)) and timestamp information on when a fix has become available, the solutions for each group can be filtered with only display the latest “top level” solution for each group being displayed. In an example, the first and second embodiments can be implemented in conjunction with each other to produce a further refined solution set.

As used herein, a “plug-in” contains logic and metadata for an individual security check in a security auditing application. A plugin may check for one or more mitigations/fixes and flag one or more individual security issues. CPE is a standardized protocol of describing and identifying classes of applications, operating systems, and hardware devices present among an enterprise's computing assets. CPE identifiers contain asset type information (OS/Hardware/Application), vendor, product, and can even contain version information. An example CPE string is “cpe:/o:microsoft:windows_vista:6.0:sp1”, where “/o” stands for operating system, Microsoft is the vendor, windows_vista is the product, major version is 6.0, and minor version is SP1. Further, a common vulnerabilities and exposures (CVE) identifier is an identifier from a national database maintained by NIST/Mitre which keeps a list of known vulnerabilities and exposures. An example identifier would be “CVE-2014-6271” which corresponds to the “ShellShock” vulnerability in the database.

In accordance with one implementation of the second embodiment, solutions (or solution ‘texts’) may first together based on the CPEs in the plugins they were reported in. The solutions are then sorted by the patch publication date from the plugins which they were sourced from. Solutions containing text that matches a pattern that indicates that the solution is likely a patch recommendation can all be removed from the group except the solution associated with the most recent patch. In this manner, patches with identifiers that cannot be easily sorted (e.g., patches with non-numerical identifiers) and/or for which no ruleset pertains in accordance with the first embodiment can be filtered out from the solution set. In some implementations, additional ruleset-based filtering from the first embodiment can also be applied, to filter out (or de-duplicate) additional duplicate solution information.

In accordance with a third embodiment, a security auditing application may evaluate further metadata in the solution report results that is added based upon asset-specific information (e.g., such as individual patches installed, which mitigations and patches are missing, what individual software installations are installed, patch supersedence information, the relationship between the mitigations/patches and security issues, etc.).

Web applications can be an essential way to conduct business. Unfortunately, web applications can also be vulnerable to attacks (e.g., denial of service, disclosure of private information, network infiltration, etc.) due to their exposure to public internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

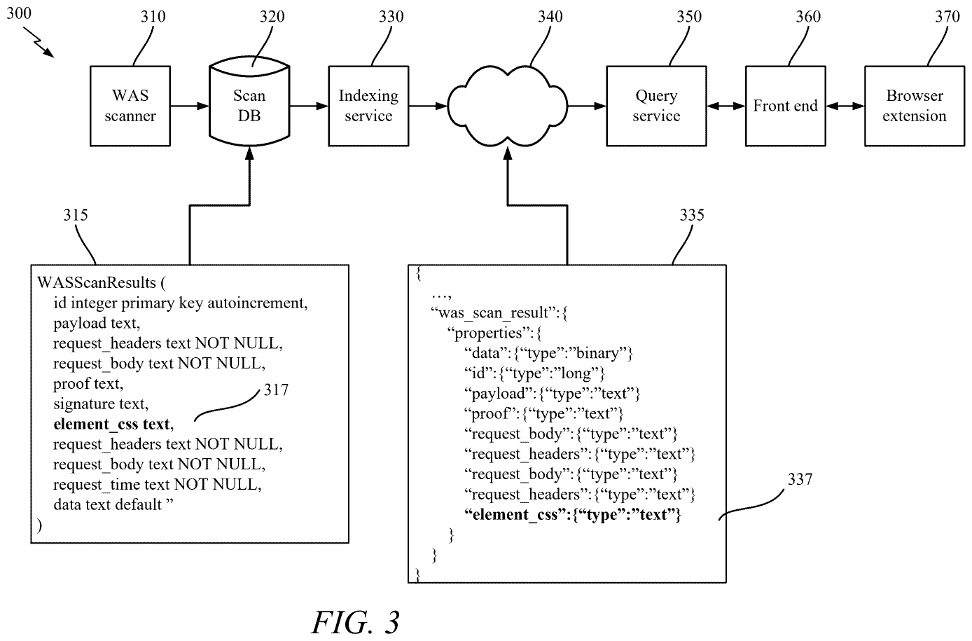

According to various aspects, FIG. 3 illustrates a diagram of an example system 300 suitable for interactive remediation of vulnerabilities of web applications based on scanning of web applications. In particular, as shown in FIG. 3, the system 300 may include a WAS scanner (or simply “scanner”) 310, a scan results 320 (e.g., a database (DB)), a first cloud service 330, a search engine 340, a second cloud service 350, a front end 360, and a browser extension 370. The first and second cloud services 330, 350 may be a same cloud service or different cloud services.

Generally, the scanner 310 may include an element selector for the vulnerable element as a part of its result placed into the scan results 320. Examples (not necessarily exhaustive) of an element selector may include CSS selector, XPath selector, Node number selector, Name selector, Id selector, LinkText selector, and so on. This information may then be passed into the search engine 340 by the first cloud service 330 and included in results from the second cloud service 350 when queried for data about specific vulnerabilities, e.g., from the front end 360. If an element selector exists, the front end 360 (e.g., browser) may include a button that links back to the vulnerable URL and element.

The scanner 310 may be configured to scan web pages to identify one or more vulnerabilities of web applications, i.e., vulnerabilities of elements in web pages. In particular, the scanner 310 may include a selector (not shown) for the vulnerable element in the scan results 320. For example, the selector may implement a scanner function (selector create function) that will take the current element and produce an element selector from it. The URL the element appears on may be included as separate data. A final test may be run before including the data to ensure that the element can be gotten to or otherwise accessible without any extra browser steps that the system is unaware of. Such data may be kept in a table in the scan results 320. For example, FIG. 3 illustrates a VulnerabilitiesDetected table 315, which includes a field for an element selector 317 denoted as “element_css”, which is of text type.

The first cloud service 330 may be configured to index the search results within scan results 320. In particular, the first cloud service 330 may be configured to ensure that the field for the element selector 317 is included when the search engine 340 performs a search. In FIG. 3, it is seen the “was_scan_results” 335 data includes the element selector data 337, which is denoted as “element_css”:{“type”:“text”}.

The second cloud service 350 may be configured to query the search engine 340 for results of WAS scanning, e.g., performed by the scanner 310. In particular, the second cloud service 350 may be configured to query the search engine 340 for the element selector data 337. For example, the second cloud service 350 may submit the following query to pick up the element selector data 337 and return its response, e.g., to the front end 360.
GET/scans/{scanId}/hosts/{hostId}/plugins/{pluginId}

The front end 360 may be configured to receive the WAS scanning results data, including the element selector data for the vulnerable elements. The front end 360 may also be configured to include a button or some other visible element, which when activated (e.g., pressed by a user) will pass message to the browser extension 370 (e.g., chrome extension). The front end 360 may pass at least the following data in the message to the browser extension 370:
URL
Element selector
Plugin ID

The browser extension 370 may be configured to take the message passed from the front end 360, open the URL, and highlight and snap to the vulnerable element. In some aspects, the browser extension 370 may open the URL in a new tab of the browser.

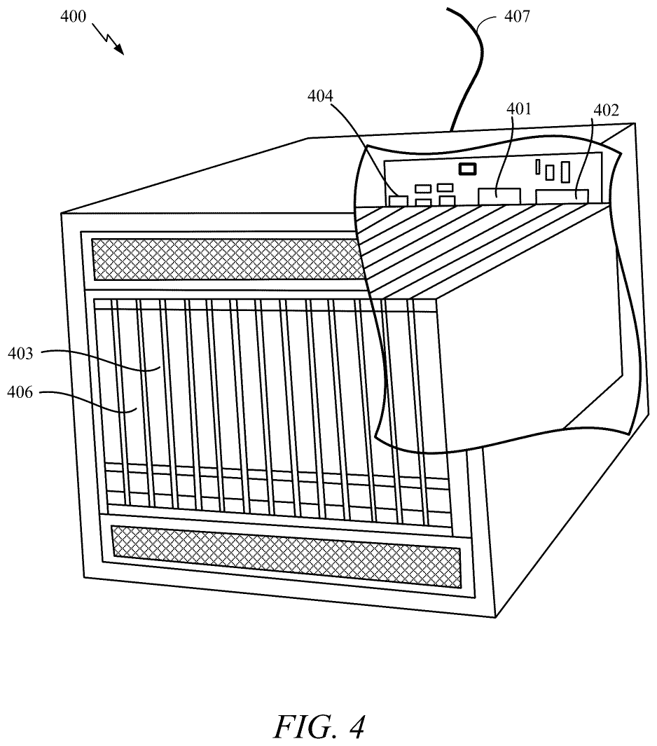

The various embodiments may be implemented on any of a variety of commercially available server devices, such as server 400 illustrated in FIG. 4. In an example, the server 400 may correspond to one example configuration of a server on which a security auditing application may execute, which in certain implementations may be included as part of the vulnerability management system 150 of FIG. 1 or the vulnerability management system 250 of FIG. 2 or WAS scanner 300 of FIG. 3. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet.

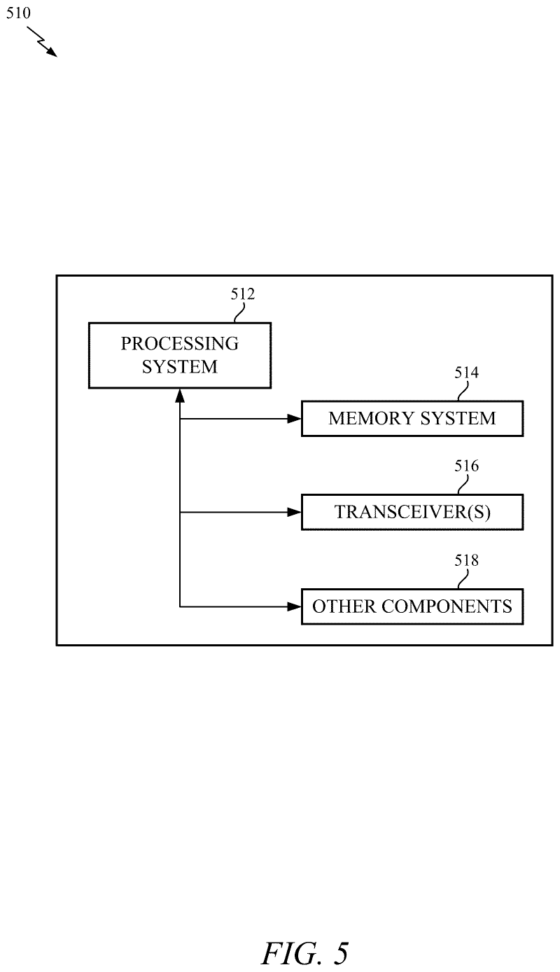

While FIG. 4 illustrates an example whereby a server-type apparatus 400 may implement various processes of the disclosure, in other aspects various aspects of the disclosure may execute on a user equipment (UE), such as UE 510 depicted in FIG. 5.

FIG. 5 generally illustrates a UE 510 in accordance with aspects of the disclosure. In some designs, UE 510 may correspond to any UE-type that is capable of executing the process(es) in accordance with aspects of the disclosure, including but not limited to a mobile phone or tablet computer, a laptop computer, a desktop computer, a wearable device (e.g., smart watch, etc.), and so on. The UE 510 depicted in FIG. 5 includes a processing system 512, a memory system 514, and at least one transceiver 516. The UE 510 may optionally include other components 518 (e.g., a graphics card, various communication ports, etc.).

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

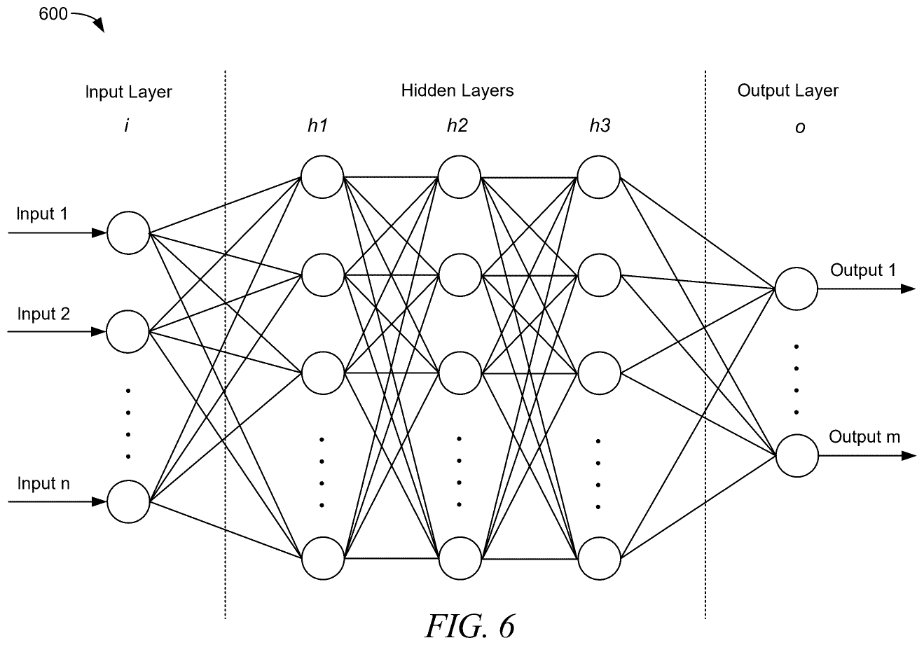

FIG. 6 illustrates an example neural network 600, according to aspects of the disclosure. The neural network 600 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

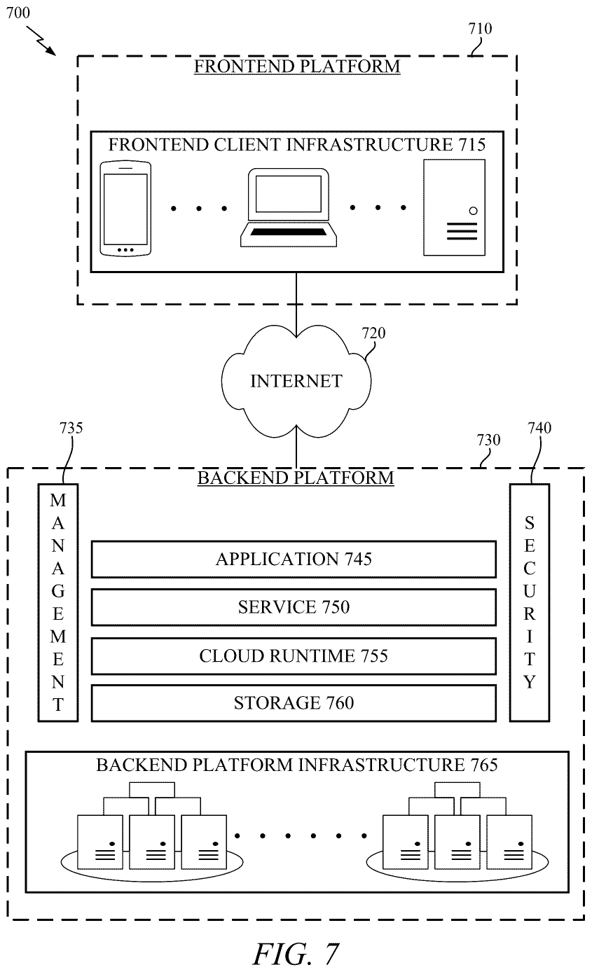

FIG. 7 illustrates cloud network architecture 700, in accordance with aspects of the disclosure. The cloud network architecture 700 comprises a frontend platform 710, an Internet 720, and a backend platform 730. The frontend platform 710 comprises frontend client infrastructure 715, such as smartphones, laptop or desktop computers, and so on, for interfacing with clients (e.g., via web browsers, client applications, etc.). The backend platform 730 comprises a management function 735, a security function 740, an application function 745, a service function 750, a cloud runtime function 755, storage 760 and backend platform infrastructure 765 (e.g., a group of distributed and interconnected computing devices with shareable hardware and/or software resources that support distributed implementation of a set of cloud applications via a respective set of cloud resources).

Referring to FIG. 7, in cloud architecture, each of the components works together to create a cloud computing platform that provides users with on-demand access to resources and services. The backend platform 730 contains all the cloud computing resources, services 750, data storage 760, and applications 745 offered by a cloud service provider. A network, such as Internet 720, is used to connect the frontend platform 710 and backend cloud architecture components of the backend platform 730, facilitating data to be sent back and forth between them. When users interact with the frontend platform (or client-side interface), the user devices send queries to the backend platform 730 using middleware where the service model carries out the specific task or request.

The types of services available to use vary depending on the cloud-based delivery model or service model you have chosen. In some designs, there are three main cloud computing service models, e.g.:
Infrastructure as a service (IaaS): This model provides on-demand access to cloud infrastructure, such as servers, storage, and networking. This eliminates the need to procure, manage, and maintain on-premises infrastructure.
Platform as a service (PaaS): This model offers a computing platform with all the underlying infrastructure and software tools needed to develop, run, and manage applications.
Software as a service (SaaS): This model offers cloud-based applications that are delivered and maintained by the service provider, eliminating the need for end users to deploy software locally.

In some designs, cloud architecture may also be characterized in terms of cloud architecture layers, e.g.:
Hardware: The servers, storage, network devices, and other hardware that power the cloud.
Virtualization: An abstraction layer that creates a virtual representation of physical computing and storage resources. This allows multiple applications to use the same resources.
Application and service: This layer coordinates and supports requests from the frontend user interface, offering different services based on the cloud service model, from resource allocation to application development tools to web-based applications.

In some designs, various types of cloud architecture may be implemented, e.g.:
Public cloud architecture uses cloud computing resources and physical infrastructure that is owned and operated by a third-party cloud service provider. Public clouds enable you to scale resources easily without having to invest in your own hardware or software, but use multi-tenant architectures that serve other customers at the same time.
Private cloud architecture refers to a dedicated cloud that is owned and managed by your organization. It is privately hosted on-premises in your own data center, providing more control over resources and more security over data and infrastructure. However, this architecture is considerably more expensive and requires more IT expertise to maintain.
Hybrid cloud architecture uses both public and private cloud architecture to deliver a flexible mix of cloud services. A hybrid cloud allows you to migrate workloads between environments, allowing you to use the services that best suit your business demands and the workload. Hybrid cloud architectures are often the solution of choice for businesses that need control over their data but also want to take advantage of public cloud offerings.
Multicloud architecture uses cloud services from multiple cloud providers. Multicloud environments are gaining popularity for their flexibility and ability to better match use cases to specific offerings, regardless of vendor.

In some designs, components of cloud architecture include:
Virtualization: Clouds are built upon the virtualization of servers, storage, and networks. Virtualized resources are a software-based, or virtual, representation of a physical resource such as servers or storage. This abstraction layer facilitates multiple applications to utilize the same physical resources, thereby increasing the efficiency of servers, storage, and networking throughout the enterprise.
Infrastructure: loud infrastructure includes all the components of traditional data centers including servers, persistent storage, and networking gear including routers and switches.
Middleware: As in traditional data centers, these software components such as databases and communications applications enable networked computers, applications, and software to communicate with each other.
Management: These tools enable continuous monitoring of a cloud environment's performance and capacity. IT teams can track usage, deploy new apps, integrate data, and ensure disaster recovery, all from a single console.
Automation software: The delivery of critical IT services through automation and pre-defined policies can significantly ease IT workloads, streamline application delivery, and reduce costs. In cloud architecture, automation is used to easily scale up system resources to accommodate a spike in demand for compute power, deploy applications to meet fluctuating market demands, or ensure governance across a cloud environment.

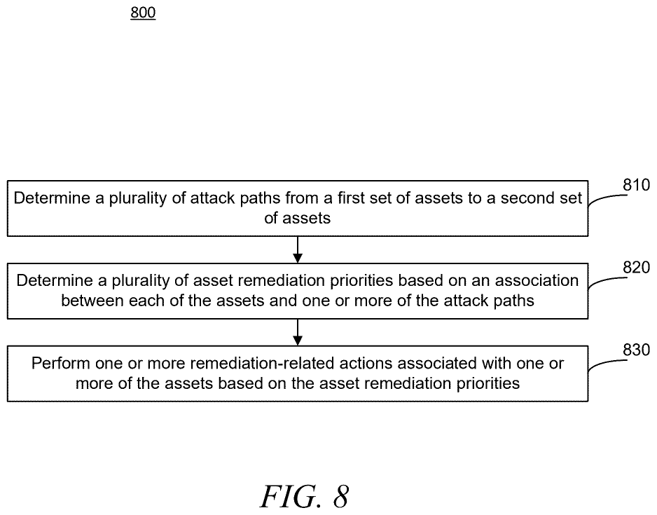

FIG. 8 illustrates a process 800, in accordance with aspects of the disclosure. The process 800 of FIG. 8 may be performed by a device, such as a network device 140, a network device 240, a cloud service 350, a server 400 or a UE 510, for example.

Referring to FIG. 8, at 810, the device (e.g., processor(s) 401, processing system 512, etc.) determines a plurality of attack paths from a first set of assets to a second set of assets.

Referring to FIG. 8, at 820, the device (e.g., processor(s) 401, processing system 512, etc.) determines a plurality of asset remediation priorities based on an association between each of the assets and one or more of the attack paths.

Referring to FIG. 8, at 830, the device (e.g., processor(s) 401, processing system 512, etc.) performs one or more remediation-related actions associated with one or more of the assets based on the asset remediation priorities.

Process 800 may include additional implementations, such as any single implementation or any combination of implementations described below and/or in connection with one or more other processes described elsewhere herein.

In some aspects, performing the one or more remediation-related actions comprises transmitting an asset remediation report.

In some aspects, performing the one or more remediation-related actions comprises performing a selective remediation on at least one of the assets.

In some aspects, the first set of assets includes a plurality of initial assets and a plurality of intermediate assets, and wherein the second set of assets includes one or more critical assets.

In some aspects, determining the asset remediation priorities comprises assigning a first priority score to the one or more critical assets.

In some aspects, determining the asset remediation priorities further comprises determining one or more attack path choke points among the intermediate assets based on a greatest number of attack path segments directly connected to each of the intermediate assets, and assigning a second priority score to the one or more attack path choke points.

In some aspects, determining the asset remediation priorities further comprises determining one or more distances based on a total number of the attack path segments from one or more of the assets in the first set to the one or more critical assets, and assigning one or more third priority scores to one or more of the assets in the first set based on the one or more distances.

In some aspects, determining the asset remediation priorities further comprises associating each asset in the first set with an asset criticality rating (ACR), and assigning a fourth priority score to one or more of the assets in the first set based on the ACR.

In some aspects, determining the asset remediation priorities further comprises assigning a fifth priority score to one or more of the assets on one or more of the attack paths other than the assets that are assigned the first, second, third or fourth priority scores.

In some aspects, determining the asset remediation priorities further comprises assigning a sixth priority score to one or more of the assets that are not on any of the attack paths.

In some aspects, performing the one or more remediation-related actions comprises performing one or more selective remediations on one or more of the assets based on one or more of the priority scores.

In some aspects, process 800 includes detecting a plurality of exposures by the assets to a plurality of vulnerabilities to obtain a plurality of detections.

In some aspects, process 800 includes generating a first mapping of the assets to the attack paths, and generating a second mapping of the assets to the detections.

In some aspects, performing the one or more remediation-related actions comprises performing one or more selective remediations on one or more of the assets based on the first mapping and the second mapping.

In some aspects, performing the one or more remediation-related actions comprises performing one or more remediations on the one or more critical assets before performing one or more remediations on one or more of the intermediate assets if the one or more critical assets and the one or more intermediate assets have a same asset remediation priority.

In some aspects, performing the one or more remediation-related actions comprises performing a remediation on one of the assets selected for the remediation before performing a remediation on another one of the assets if one of the assets selected for the remediation has no compensating security control.

In some aspects, the compensating security control comprises detection and response (EDR), antiviral software, local firewall, or any combination thereof.

Although FIG. 8 shows example blocks of process 800, in some implementations, process 800 may include additional blocks, fewer blocks, different blocks, or differently arranged blocks from those depicted in FIG. 8. Additionally, or alternatively, two or more of the blocks of process 800 may be performed in parallel, or performed in a sequence different from the sequence depicted in FIG. 8.

In some aspects, systems and methods are provided for identifying key assets that are prioritized for remediation. In some aspects, detections that require immediate attention are identified and targeted solutions for remediation are developed for those detections. In some aspects, remediation solutions such as software patches may follow a hierarchical structure, which may allow system operators to focus on applying software patches to address prioritized high-level threats rather than all threats equally. By prioritizing the threats and remediating them accordingly, network security may be improved while workload on the part of security response teams may be reduced.

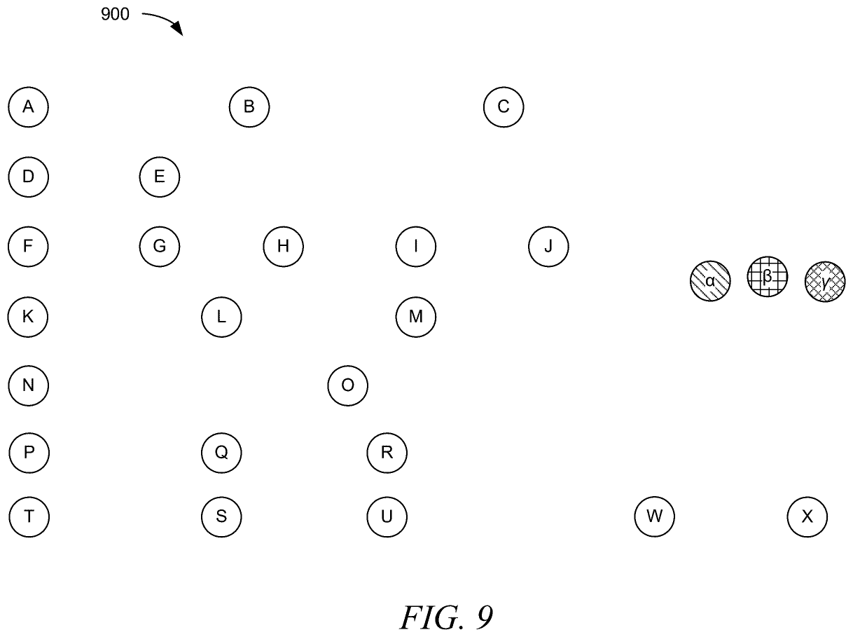

In some aspects, exposures to vulnerabilities may be analyzed through a graph structure of computing environments. FIG. 9 illustrates an example of a graph 900 representing a customer computing environment, according to aspects of the disclosure. In the example illustrated in FIG. 9, each customer asset is represented by a circle denoted by a character. In this example, the customer assets are denoted with English characters A, B, C, . . . . X, except for three assets which are denoted with Greek characters α, β, and γ.

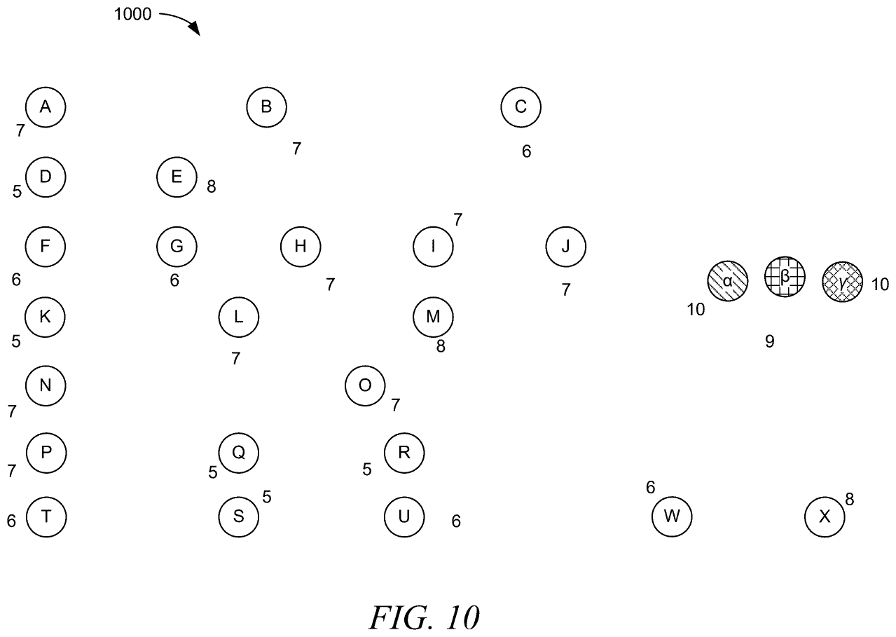

FIG. 10 illustrates an example of a graph 1000 representing a customer computing environment in which each customer asset is assigned an asset criticality rating (ACR), according to aspects of the disclosure. In the example illustrated in FIG. 10, each of the assets is associated with an ACR which is indicative of the level of criticality or importance to the customer.

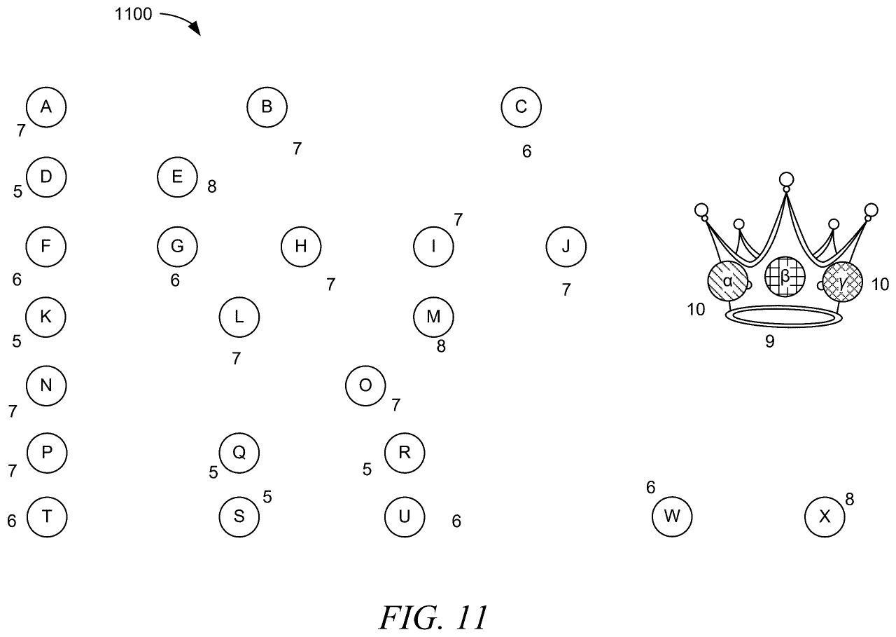

In some aspects, with the introduction of attack path analytics (APA), the prioritization strategy for remediation may be further extended with the notion of what may be regarded as “crown jewels,” which are critical assets identified based on the ACRs and other considerations associated with these assets, including the presence of assets on important devices, cloud resources, and/or storage with sensitive or privileged data associated with these accounts, for example. In some aspects, the crown jewels may be regarded as critical assets or assets of high value to the customer. FIG. 11 illustrates an example of a graph 1100 representing a customer computing environment in which the critical assets are labeled as crown jewels, according to aspects of the disclosure. In this example, these crown jewels are the assets denoted with Greek characters α, β, and γ.

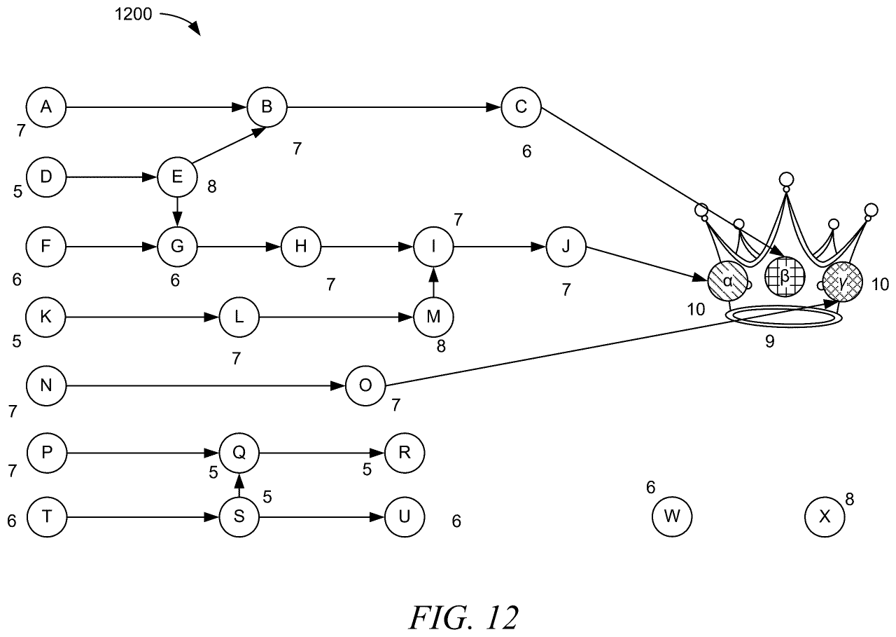

In some aspects, potential attack paths from various customer assets leading to the crown jewels through the computer network may be discovered with the assistance of APA. FIG. 12 illustrates an example of a graph 1200 representing a customer computing environment with a plurality of attack paths leading to the critical assets, according to aspects of the disclosure. In the example illustrated in FIG. 12, some of the customer assets (e.g., A, B, C, . . . . O) including initial assets (e.g., A, D, F, K, N) and intermediate assets (e.g., B, C, E, G, . . . ) are on the attack paths leading to the critical assets (e.g., α, β, γ).

In the example shown in FIG. 12, critical asset β may be reached by one of the two routes: A->B->C->β or D->E->B->C->β. Critical asset α may be reached by one of the three routes: D->E->G->H->I->J->α, F->G->H->I->J->α, or K->L->M->I->J->α. Critical asset γ may be reached by the route: N->O->γ.

In some aspects, a graph such as the one illustrated in FIG. 12 may not yet be actionable because it may not be apparent as to which of the assets should be prioritized for remediation. In some aspects, different priority scores may be assigned to different assets in the computer network.

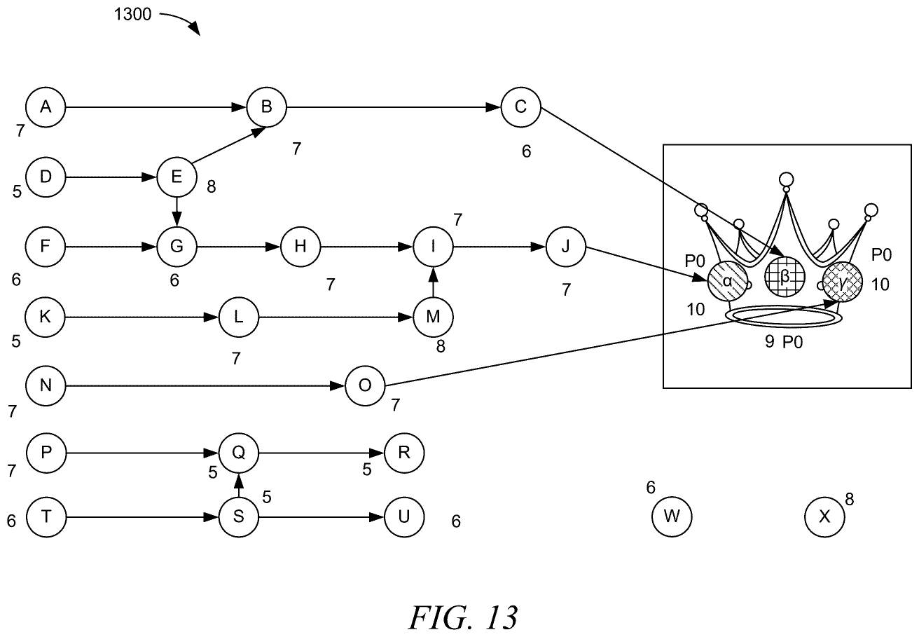

FIG. 13 illustrates an example of a graph 1300 representing a customer computing environment in which the critical assets are assigned a priority score indicating the highest level of priority, according to aspects of the disclosure. In the example illustrated in FIG. 13, a priority score indicating the highest priority level (e.g., a priority level of P0) may be assigned to the critical assets α, β, and γ, which are regarded as crown jewels.

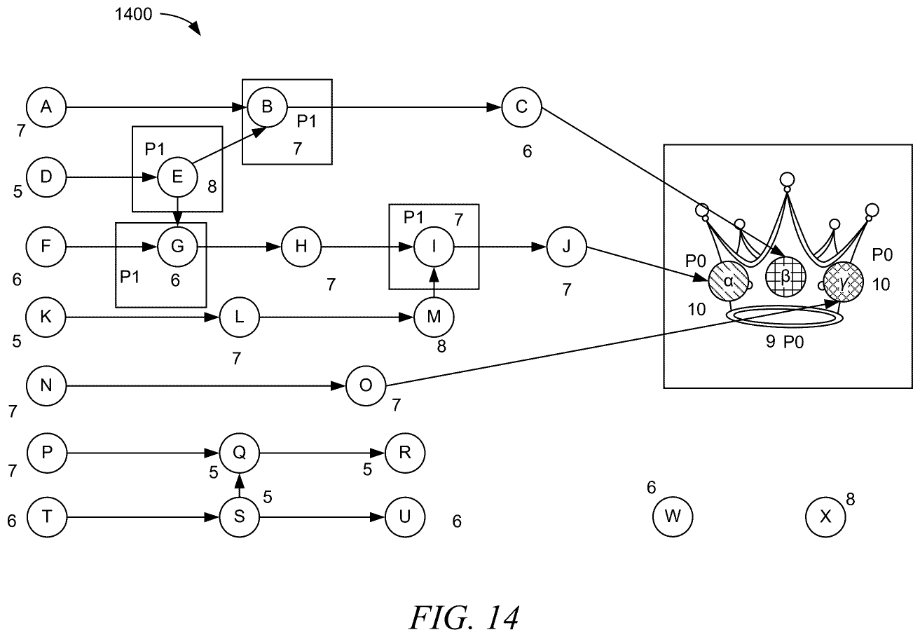

FIG. 14 illustrates an example of a graph 1400 representing a customer computing environment in which assets at choke points of attack paths are assigned a priority score, according to aspects of the disclosure. In some aspects, the choke points are the graph nodes representing intermediate assets having a large number of directly connected attack path segments, including incoming and outgoing attack path segments.

In the example illustrated in FIG. 14, asset B has two incoming attack path segments and one outgoing attack path segment. Likewise, assets G and I each have two incoming attack path segments and one outgoing attack path segment. In contrast, asset E has one incoming attack path segment and two outgoing attack path segments.

Among the nodes representing the intermediate assets in the example illustrated in FIG. 14, the nodes representing assets B, E, G and I may be regarded as choke points. In this example, a priority score indicating a relatively high priority level (e.g., a priority level of P1) but lower than the highest priority level (P0) for the critical assets α, β, and γ may be assigned to the intermediate assets B, E, G and I at respective choke points. In some aspects, remediating the assets at these choke points may have a significant impact on the overall remediation scheme because such remediations at choke points may cause many of the attack paths to disappear.

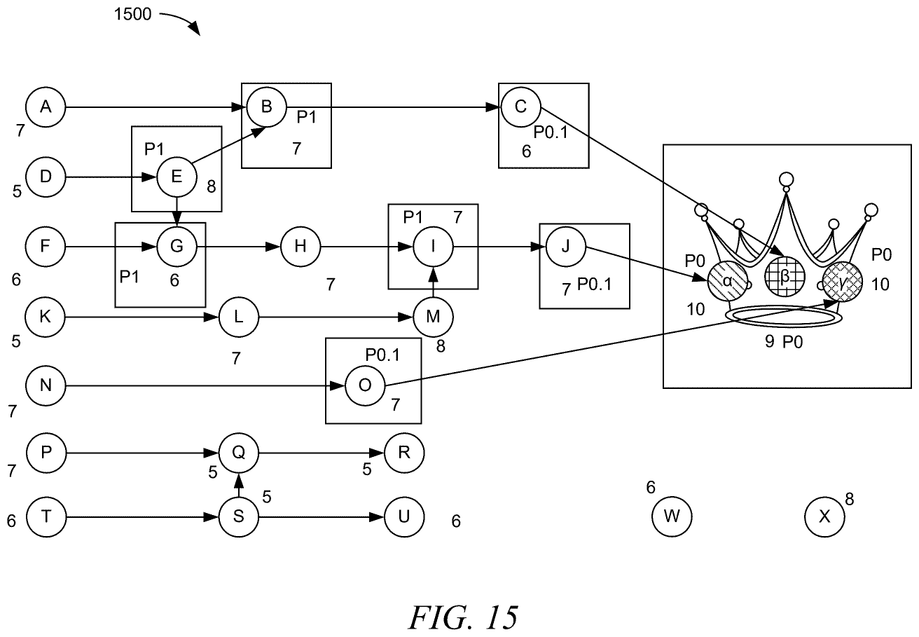

FIG. 15 illustrates an example of a graph 1500 representing a customer computing environment in which assets having direct attack paths to the critical assets are assigned a priority score, according to aspects of the disclosure. In the example illustrated in FIG. 15, there are paths such as N->O->γ that do not include any of the choke points but may include nodes that have relatively short distances to one of the critical assets (e.g., asset γ). Such paths may be relatively easy to exploit by attackers due to the relatively short distances to one of the critical assets.

In some aspects, the node representing asset O that has a direct attack path to critical asset γ may be assigned a priority level somewhere between P0 and P1. In the example illustrated in FIG. 15, the node representing asset O is assigned a priority level of P0.1. Likewise, the node representing asset C, which has a direct attack path to critical asset β, and the node representing asset J, which has a direct attack path to critical asset α, are also assigned a priority level of P0.1.

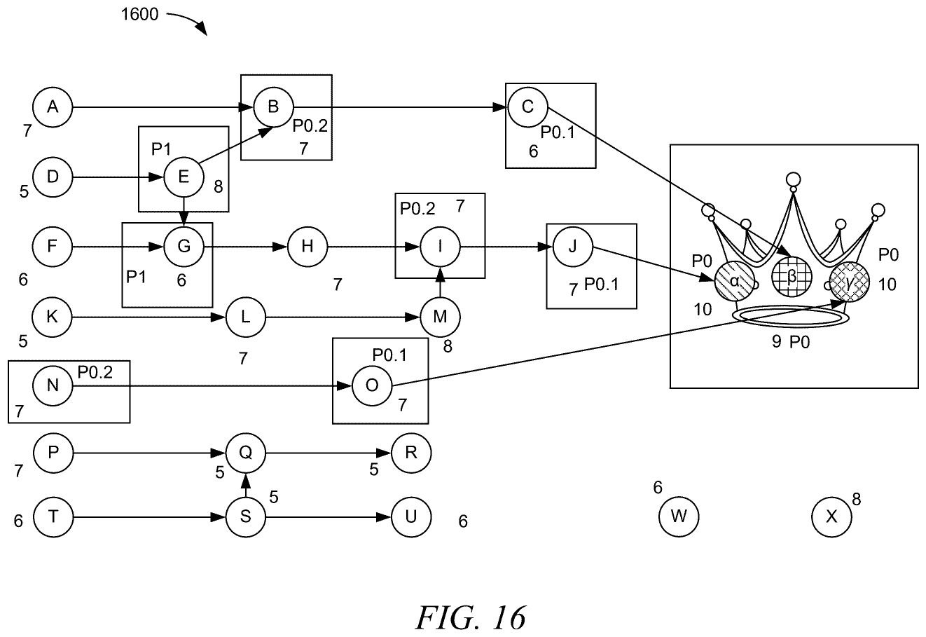

In some aspects, nodes representing assets that do not have direct attack paths to critical assets but have relatively short distances to those critical assets may be assigned priority scores lower than the assets that have direct attack paths (e.g., nodes with a priority level of P0.1) but still higher than the choke point assets (e.g., nodes with a priority level of P1). FIG. 16 illustrates an example of a graph 1600 representing a customer computing environment in which assets having relatively short paths to the critical assets are assigned a priority score, according to aspects of the disclosure.

In the example illustrated in FIG. 16, a priority level of P0.2 is assigned to nodes on relatively short paths to the critical assets α, β, and γ. For example, the node representing asset B is two hops away from critical asset β, the node representing asset I is two hops away from critical asset α, and the node representing asset N is two hops away from critical asset γ. In this example, it is noted that the nodes representing assets B and I, which were previously assigned the priority level of P1 for being choke points, have been upgraded to the priority level of P0.2 due to their short distances (two hops) to the critical assets. In some aspects, the notation P0.x may be used for indicating priority levels associated with distances to the critical assets, where x is the distance from each node to one of the critical assets.

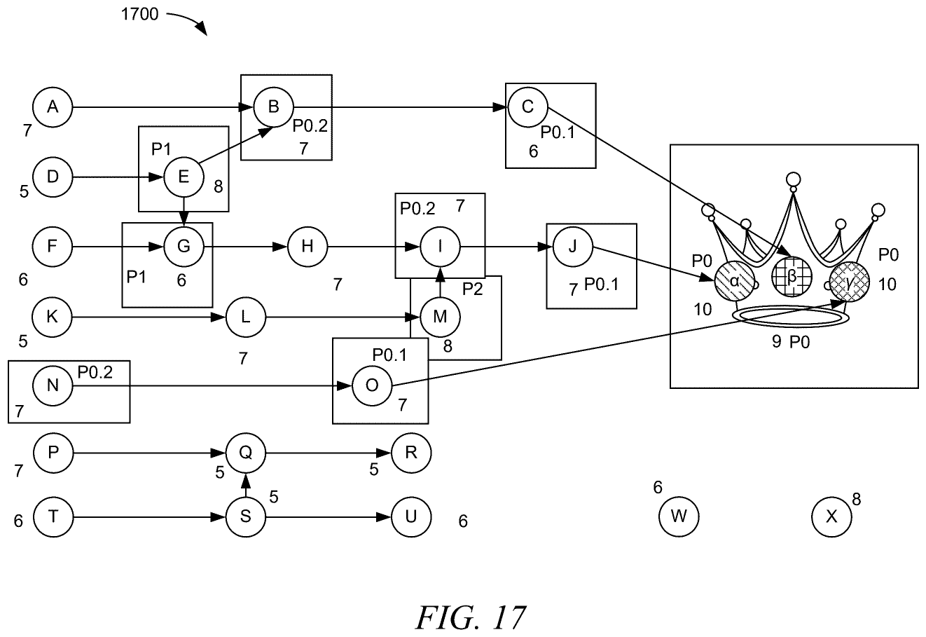

FIG. 17 illustrates an example of a graph 1700 representing a customer computing environment in which assets having a relatively high ACR are assigned a priority score, according to aspects of the disclosure. In some aspects, among the initial and intermediate assets, those with relatively high ACRs may be identified and assigned a priority score that indicates a lower priority than the critical assets, assets with direct attack paths or relatively short distances to the critical assets, and assets at choke points of attack paths.

In the example illustrated in FIG. 17, the node representing asset M is assigned a priority level of P2 because it has a relatively high ACR of 8. Although remediating asset I would remove the M->I path from potential attacks, it may be desirable in some circumstances to allow the attacker to be able to reach the node representing asset M to lure the attacker into falsely thinking that this node is relevant.

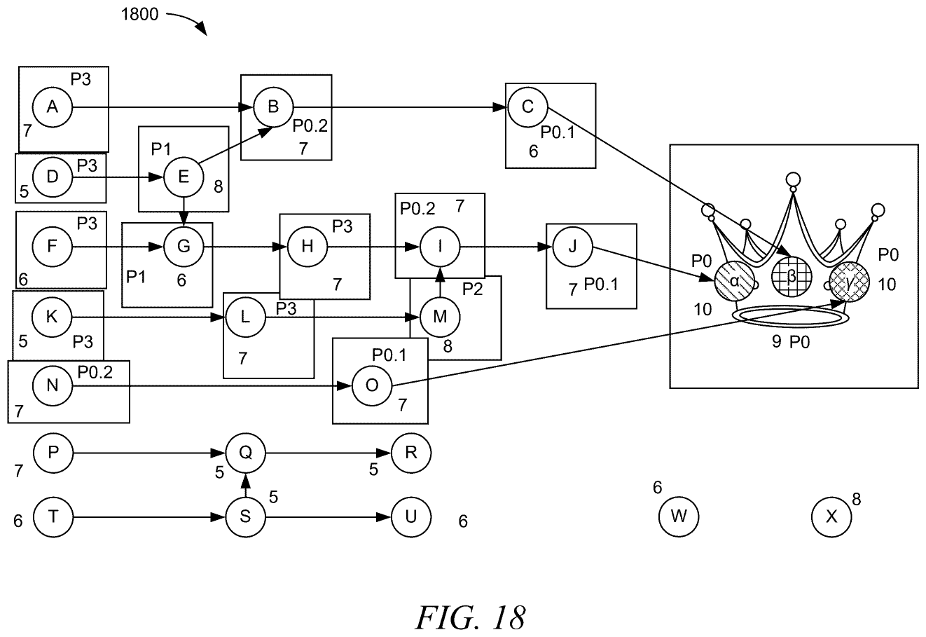

FIG. 18 illustrates an example of a graph 1800 representing a customer computing environment in which assets on any of the attack paths are assigned a priority score, according to aspects of the disclosure. In the example illustrated in FIG. 18, the remaining nodes representing initial and intermediate assets that are on any of the attack paths but have not yet been assigned priority scores (e.g., nodes A, D, F, H, K, L) are assigned a priority level of P3.

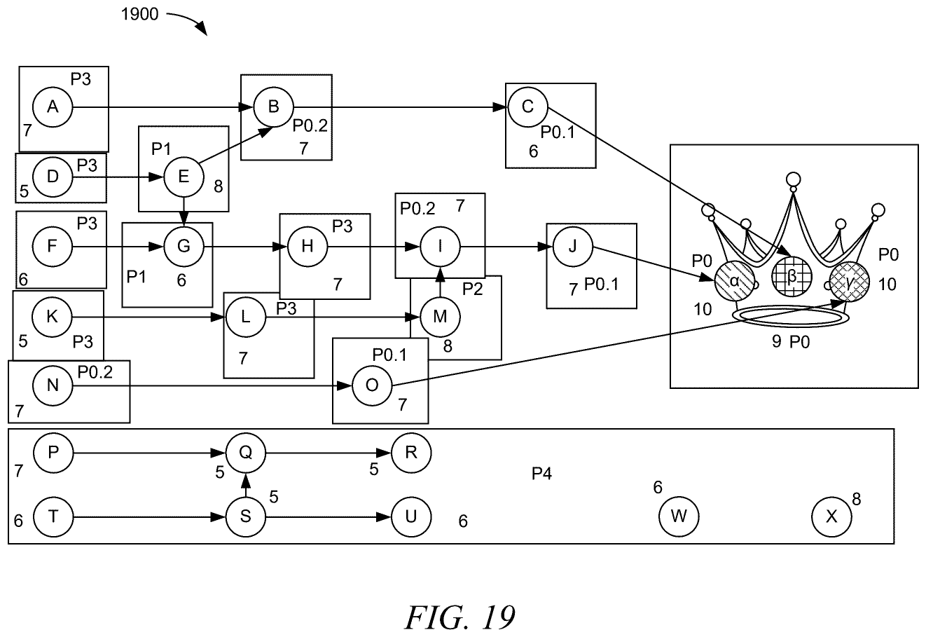

FIG. 19 illustrates an example of a graph 1900 representing a customer computing environment in which assets that are not on any of the attack paths are assigned a priority score, according to aspects of the disclosure. In the example illustrated in FIG. 19, a priority level of P4 is assigned to nodes representing assets that are not on any of the attack paths leading to any of the critical assets (e.g., nodes P, Q, R, T, S, U, W, X).

In the examples described above with respect to FIGS. 9-19, remediations of various assets may be performed in the following order:
P0: α, β, γ
P0.1: C, J, O
P0.2: B, I, N
P1: E, G
P2: M
P3: A, D, F, K, H, L
P4: P, Q, R, T, S, U, W, X

In typical situations, for most customers, assets at lower priority levels (e.g., P2, P3 and P4) may not need to be remediated. In these situations, it may be sufficient to focus on assets that are assigned higher priority levels (e.g., P0, P0.x and P1). For example, critical assets (e.g., P0 assets), assets that have direct attack paths to the critical assets or have relatively short distances to the critical assets (e.g., P0.1 and P0.2 assets), and assets at choke points of attack paths (e.g., P1 assets) may need to be considered for remediation.

As used herein, a “vulnerability” refers to a flaw or weakness in a system, application, or process that may be exploited by an attacker to gain unauthorized access or cause harm. In some aspects, a vulnerability represents a potential point of attack. As used herein, an “exposure” refers to a detected state of vulnerability identified by security sensors, representing a potential risk that has not yet been mitigated. In some aspects, an exposure is a condition that needs to be managed in order to prevent the associated risk from materializing.

In the context of vulnerability, an exposure refers to the state of a system or component being vulnerable to potential threats. In other words, an exposure is a condition in which a system is at risk due to the presence of vulnerabilities, misconfigurations, or other weaknesses. In some aspects, exposures may be detected from the nodes representing critical assets or crown jewels and other customer assets (e.g., initial and/or intermediate assets) that may lead to the critical assets.

In some aspects, problematic assets may be identified and prioritized within the customer computing environment. In some aspects, those assets that are likely causing exposures may be selected for remediation. In some aspects, all potential attack paths and their associated assets may be listed, and then these attack paths may be broken down by starting with the highest-impact node(s).

In some aspects, a process for eliminating attack paths that pose no risk or a relatively low risk is provided to reduce the amount of work required for remediating customer assets that are likely causing exposures. An example of this process may include the following steps (Steps 1 through 7):
1. Create a list of all attack paths sorted by their priorities;
2. Create two mappings:
   a. nodes to paths;
   b. nodes to detections;
3. Iterate through each attack path starting with the highest priority;
4. Determine and remove the most impactful node on the path;
5. Note required work with nodes and detections obtained;
6. As part of an asset profile algorithm (e.g., Tenable's Global Asset Profile (GAP) algorithm), identify the person (or team) who owns each node to support remediation workflows;
7. Remove all other attack paths from the dataset based on the nodes and detections;
8. If there are more paths, return to Step 3. Otherwise, finish.

In some aspects, by performing the above-described process, all attack paths likely causing exposures may be removed to produce a minimally required amount of nodes and detections that will require remediation.

In some aspects, for each detection, the work required for remediation may be listed. In some implementations, the hierarchical nature of certain solutions, such as software patches, may be utilized to minimize the amount of work required for remediation. For instance, if detections A, B, and C require patches A′, B′, and C′, respectively, there may often be a roll-up patch (which may be called patch D′) that addresses all the previous fixes introduced in patches A′, B′, and C′. By recognizing this hierarchical structure, the minimum number of weaknesses that need to be addressed may be determined, and the amount of work required to remediate them may thus be minimized.

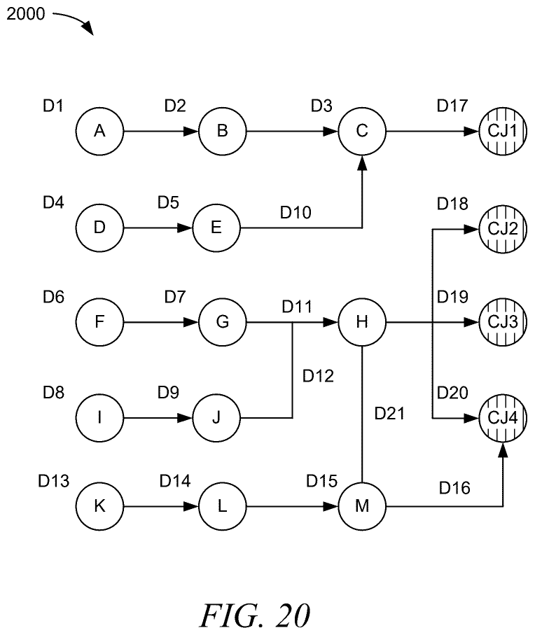

FIG. 20 illustrates an example of a computing graph 2000 that includes paths, nodes and their corresponding detections, according to aspects of the disclosure. For the example illustrated in FIG. 20, the identified paths and their associated path priorities, steps (i.e., the nodes on each path), and exposures are shown in Table 1 below:

TABLE 1

| Path ID | Path priority | Step 1 | Step 2 | Step 3 | Step 4 | Exposure |
|---|---|---|---|---|---|---|
| 1 | 6 | A | B | C | | CJ1 |
| 2 | 5 | D | E | C | | CJ1 |
| 3 | 3 | F | G | H | | CJ2 |
| 4 | 6 | F | G | H | | CJ3 |
| 5 | 5 | F | G | H | | CJ4 |
| 6 | 4 | I | J | H | | CJ2 |
| 7 | 2 | I | J | H | | CJ3 |
| 8 | 4 | I | J | H | | CJ4 |
| 9 | 4 | I | J | H | M | CJ4 |
| 10 | 5 | K | L | M | | CJ4 |

In Step 1, these paths may be sorted by priority and analyzed in the following order: 1, 4, 2, 5, 10, 6, 8, 9, 3, 7.

In Step 2, mappings of nodes to paths and nodes to detections may be constructed, including mappings of nodes to paths in Step 2(a) and mappings of nodes to detections in Step 2(b). An example of mappings of nodes to path identifiers (IDs) in Step 2(a) is shown in Table 2 below:

TABLE 2

| Node | Path IDs |
|---|---|
| CJ1 | 1, 2 |
| CJ2 | 3, 6 |
| CJ3 | 4, 7 |
| CJ4 | 5, 8, 9, 10 |
| A | 1 |
| B | 1 |
| C | 1, 2 |
| D | 2 |
| E | 2 |
| F | 3, 4, 5 |
| G | 3, 4, 5 |
| H | 3, 4, 5, 6, 7, 8, 9 |
| I | 6, 7, 8, 9 |
| J | 6, 7, 8, 9 |
| K | 10 |
| L | 10 |
| M | 9, 10 |

An example of mappings of nodes to detections in Step 2(b) is shown in Table 3 below:

TABLE 3

| Node | Detections |
|---|---|
| CJ1 | D17 |
| CJ2 | D18 |
| CJ3 | D19 |
| CJ4 | D16, D20 |
| A | D1 |
| B | D2 |
| C | D3, D10 |
| D | D4 |
| E | D5 |
| F | D6 |
| G | D7 |
| H | D11, D12 |
| I | D8 |
| J | D9 |
| K | D13 |
| L | D14 |
| M | D15, D21 |

In Step 3, the iterative process may begin with path 1, for example. In Step 4, it may be determined that assets C and CJ1 have the same impact (i.e., two paths each). In this situation, asset CJ1 may be selected over asset C because CJ1 presumably has a higher ACR. This may require addressing detection D17 and remediating asset CJ1 in Step 5, which will address paths 1 and 2. In Steps 6, both Paths 1 and 2 may be removed from the path list sorted by priority, and the process may return to Step 3 with an updated list of paths.

In the next step (i.e., a first repetition of Step 3), path 4 that includes nodes F, G, H, CJ3 may be addressed. After Step 3 is performed, it may be noted that node H has the highest impact since there are seven paths going through node H (i.e., paths 3, 4, 5, 6, 7, 8, and 9). In some aspects, node H may be regarded as being more impactful than node CJ3, which may be reached by two paths (i.e., paths 4 and 7). Then, detections D12 and D12 may need to be addressed in Step 5, and paths 3, 4, 5, 6, 7, 8 and 9 may be removed from the list of paths in Step 6.

In the next step (i.e., a second repetition of Step 3), the remaining path is path 10, which may be addressed by remediating node M or node CJ4. In some aspects, node CJ4 may be selected for remediation because it is a presumably more important node and is associated with detection D16 (Step 5). After remediating node CJ4, there are no other paths to be eliminated, and the process ends.

In the above-described example, the required amount of work is reduced to fixing detections D16, D17, D11, and D12. Since detections D11 and D12 are on the same machine (detections D11 and D12 at the same node H), a further verification may be made as to whether they may be addressed with a single software patch instead of two due to the aforementioned hierarchical nature of software patches.

In some aspects, the amount of remediation work required in the above-described example may be reduced from addressing twenty-one detections to addressing just three or four, and the number of machines that need to be interacted with in the remediation process may be reduced from seventeen to three.

In some situations, systems and methods according to aspects of the disclosure may not remove all the possible detections from the computing environment, but may be able to significantly reduce the amount of required remediation work and to eliminate the likelihood of lateral attack path movements in order to reach high-value targets.

In some aspects, a scheme for graph-based network prioritization is provided which selectively prioritizes the assets for remediation, thereby greatly reducing the amount of work required on the part of cybersecurity response teams. In typical situations, not all assets may need to be remediated, and not all weaknesses may need to be addressed, at least not at the highest level of priority, in order to protect them from lateral attack path movements.

In some aspects, various types of exposures may be detected and identified. In some aspects, various types of security risks may be prioritized across different cyber domains, including software vulnerabilities, cloud misconfigurations, identity access, network, and/or operational technology (OT), for example.

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method, performed by a device, comprising: determining a plurality of attack paths from a first set of assets to a second set of assets; determining a plurality of asset remediation priorities based on an association between each of the assets and one or more of the attack paths; and performing one or more remediation-related actions associated with one or more of the assets based on the asset remediation priorities.

Clause 2. The method of clause 1, wherein performing the one or more remediation-related actions comprises: transmitting an asset remediation report.

Clause 3. The method of any of clauses 1 to 2, wherein performing the one or more remediation-related actions comprises: performing a selective remediation on at least one of the assets.

Clause 4. The method of any of clauses 1 to 3, wherein the first set of assets includes a plurality of initial assets and a plurality of intermediate assets, and wherein the second set of assets includes one or more critical assets.

Clause 5. The method of clause 4, wherein determining the asset remediation priorities comprises: assigning a first priority score to the one or more critical assets.

Clause 6. The method of clause 5, wherein determining the asset remediation priorities further comprises: determining one or more attack path choke points among the intermediate assets based on a greatest number of attack path segments directly connected to each of the intermediate assets; and assigning a second priority score to the one or more attack path choke points.

Clause 7. The method of clause 6, wherein determining the asset remediation priorities further comprises: determining one or more distances based on a total number of the attack path segments from one or more of the assets in the first set to the one or more critical assets; and assigning one or more third priority scores to one or more of the assets in the first set based on the one or more distances.

Clause 8. The method of clause 7, wherein determining the asset remediation priorities further comprises: associating each asset in the first set with an asset criticality rating (ACR); and assigning a fourth priority score to one or more of the assets in the first set based on the ACR.

Clause 9. The method of clause 8, wherein determining the asset remediation priorities further comprises: assigning a fifth priority score to one or more of the assets on one or more of the attack paths other than the assets that are assigned the first, second, third or fourth priority scores.

Clause 10. The method of clause 9, wherein determining the asset remediation priorities further comprises: assigning a sixth priority score to one or more of the assets that are not on any of the attack paths.

Clause 11. The method of clause 10, wherein performing the one or more remediation-related actions comprises: performing one or more selective remediations on one or more of the assets based on one or more of the priority scores.

Clause 12. The method of any of clauses 4 to 11, further comprising: detecting a plurality of exposures by the assets to a plurality of vulnerabilities to obtain a plurality of detections.

Clause 13. The method of clause 12, further comprising: generating a first mapping of the assets to the attack paths; and generating a second mapping of the assets to the detections.

Clause 14. The method of clause 13, wherein performing the one or more remediation-related actions comprises: performing one or more selective remediations on one or more of the assets based on the first mapping and the second mapping.

Clause 15. The method of any of clauses 4 to 14, wherein performing the one or more remediation-related actions comprises: performing one or more remediations on the one or more critical assets before performing one or more remediations on one or more of the intermediate assets if the one or more critical assets and the one or more intermediate assets have a same asset remediation priority.

Clause 16. The method of any of clauses 4 to 15, wherein performing the one or more remediation-related actions comprises: performing a remediation on one of the assets selected for the remediation before performing a remediation on another one of the assets if one of the assets selected for the remediation has no compensating security control.

Clause 17. The method of clause 16, wherein the compensating security control comprises: endpoint detection and response (EDR); antiviral software; local firewall; or any combination thereof.

Clause 18. A device, comprising: one or more memories; and one or more processors communicatively coupled to the one or more memories, the one or more processors, either alone or in combination, configured to: determine a plurality of attack paths from a first set of assets to a second set of assets; determine a plurality of asset remediation priorities based on an association between each of the assets and one or more of the attack paths; and perform one or more remediation-related actions associated with one or more of the assets based on the asset remediation priorities.

Clause 19. The device of clause 18, wherein the one or more processors configured to perform the one or more remediation-related actions comprise the one or more processors, either alone or in combination, configured to: transmit an asset remediation report.

Clause 20. The device of any of clauses 18 to 19, wherein the one or more processors configured to perform the one or more remediation-related actions comprise the one or more processors, either alone or in combination, configured to: perform a selective remediation on at least one of the assets.

Clause 21. The device of any of clauses 18 to 20, wherein the first set of assets includes a plurality of initial assets and a plurality of intermediate assets, and wherein the second set of assets includes one or more critical assets.

Clause 22. The device of clause 21, wherein the one or more processors configured to determine the asset remediation priorities comprise the one or more processors, either alone or in combination, configured to: assign a first priority score to the one or more critical assets.

Clause 23. The device of clause 22, wherein the one or more processors configured to determine the asset remediation priorities comprise the one or more processors, either alone or in combination, configured to: determine one or more attack path choke points among the intermediate assets based on a greatest number of attack path segments directly connected to each of the intermediate assets; and assign a second priority score to the one or more attack path choke points.

Clause 24. The device of clause 23, wherein the one or more processors configured to determine the asset remediation priorities comprise the one or more processors, either alone or in combination, configured to: determine one or more distances based on a total number of the attack path segments from one or more of the assets in the first set to the one or more critical assets; and assign one or more third priority scores to one or more of the assets in the first set based on the one or more distances.

Clause 25. The device of clause 24, wherein the one or more processors configured to determine the asset remediation priorities comprise the one or more processors, either alone or in combination, configured to: associate each asset in the first set with an asset criticality rating (ACR); and assign a fourth priority score to one or more of the assets in the first set based on the ACR.

Clause 26. The device of clause 25, wherein the one or more processors configured to determine the asset remediation priorities comprise the one or more processors, either alone or in combination, configured to: assign a fifth priority score to one or more of the assets on one or more of the attack paths other than the assets that are assigned the first, second, third or fourth priority scores.

Clause 27. The device of clause 26, wherein the one or more processors configured to determine the asset remediation priorities comprise the one or more processors, either alone or in combination, configured to: assign a sixth priority score to one or more of the assets that are not on any of the attack paths.

Clause 28. The device of clause 27, wherein the one or more processors configured to perform the one or more remediation-related actions comprise the one or more processors, either alone or in combination, configured to: perform one or more selective remediations on one or more of the assets based on one or more of the priority scores.

Clause 29. The device of any of clauses 21 to 28, wherein the one or more processors, either alone or in combination, are further configured to: detect a plurality of exposures by the assets to a plurality of vulnerabilities to obtain a plurality of detections.

Clause 30. The device of clause 29, wherein the one or more processors, either alone or in combination, are further configured to: generate a first mapping of the assets to the attack paths; and generate a second mapping of the assets to the detections.

Clause 31. The device of clause 30, wherein the one or more processors configured to perform the one or more remediation-related actions comprise the one or more processors, either alone or in combination, configured to: perform one or more selective remediations on one or more of the assets based on the first mapping and the second mapping.

Clause 32. The device of any of clauses 21 to 31, wherein the one or more processors configured to perform the one or more remediation-related actions comprise the one or more processors, either alone or in combination, configured to: perform one or more remediations on the one or more critical assets before performing one or more remediations on one or more of the intermediate assets if the one or more critical assets and the one or more intermediate assets have a same asset remediation priority.

Clause 33. The device of any of clauses 21 to 32, wherein the one or more processors configured to perform the one or more remediation-related actions comprise the one or more processors, either alone or in combination, configured to: perform a remediation on one of the assets selected for the remediation before performing a remediation on another one of the assets if one of the assets selected for the remediation has no compensating security control.

Clause 34. The device of clause 33, wherein the compensating security control comprises: endpoint detection and response (EDR); antiviral software; local firewall; or any combination thereof.

Clause 35. A non-transitory computer-readable medium stores computer-executable instructions that, when executed by a device, cause the device to: determine a plurality of attack paths from a first set of assets to a second set of assets; determine a plurality of asset remediation priorities based on an association between each of the assets and one or more of the attack paths; and perform one or more remediation-related actions associated with one or more of the assets based on the asset remediation priorities.

Clause 36. The non-transitory computer-readable medium of clause 35, wherein the computer-executable instructions that, when executed by the device, cause the device to perform the one or more remediation-related actions comprise computer-executable instructions that, when executed by the device, cause the device to: transmit an asset remediation report.

Clause 37. The non-transitory computer-readable medium of any of clauses 35 to 36, wherein the computer-executable instructions that, when executed by the device, cause the device to perform the one or more remediation-related actions comprise computer-executable instructions that, when executed by the device, cause the device to: perform a selective remediation on at least one of the assets.

Clause 38. The non-transitory computer-readable medium of any of clauses 35 to 37, wherein the first set of assets includes a plurality of initial assets and a plurality of intermediate assets, and wherein the second set of assets includes one or more critical assets.

Clause 39. The non-transitory computer-readable medium of clause 38, wherein the computer-executable instructions that, when executed by the device, cause the device to determine the asset remediation priorities comprise computer-executable instructions that, when executed by the device, cause the device to: assign a first priority score to the one or more critical assets.

Clause 40. The non-transitory computer-readable medium of clause 39, wherein the computer-executable instructions that, when executed by the device, cause the device to determine the asset remediation priorities comprise computer-executable instructions that, when executed by the device, cause the device to: determine one or more attack path choke points among the intermediate assets based on a greatest number of attack path segments directly connected to each of the intermediate assets; and assign a second priority score to the one or more attack path choke points.

Clause 41. The non-transitory computer-readable medium of clause 40, wherein the computer-executable instructions that, when executed by the device, cause the device to determine the asset remediation priorities comprise computer-executable instructions that, when executed by the device, cause the device to: determine one or more distances based on a total number of the attack path segments from one or more of the assets in the first set to the one or more critical assets; and assign one or more third priority scores to one or more of the assets in the first set based on the one or more distances.

Clause 42. The non-transitory computer-readable medium of clause 41, wherein the computer-executable instructions that, when executed by the device, cause the device to determine the asset remediation priorities comprise computer-executable instructions that, when executed by the device, cause the device to: associate each asset in the first set with an asset criticality rating (ACR); and assign a fourth priority score to one or more of the assets in the first set based on the ACR.

Clause 43. The non-transitory computer-readable medium of clause 42, wherein the computer-executable instructions that, when executed by the device, cause the device to determine the asset remediation priorities comprise computer-executable instructions that, when executed by the device, cause the device to: assign a fifth priority score to one or more of the assets on one or more of the attack paths other than the assets that are assigned the first, second, third or fourth priority scores.

Clause 44. The non-transitory computer-readable medium of clause 43, wherein the computer-executable instructions that, when executed by the device, cause the device to determine the asset remediation priorities comprise computer-executable instructions that, when executed by the device, cause the device to: assign a sixth priority score to one or more of the assets that are not on any of the attack paths.

Clause 45. The non-transitory computer-readable medium of clause 44, wherein the computer-executable instructions that, when executed by the device, cause the device to perform the one or more remediation-related actions comprise computer-executable instructions that, when executed by the device, cause the device to: perform one or more selective remediations on one or more of the assets based on one or more of the priority scores.

Clause 46. The non-transitory computer-readable medium of any of clauses 38 to 45, further comprising computer-executable instructions that, when executed by the device, cause the device to: detect a plurality of exposures by the assets to a plurality of vulnerabilities to obtain a plurality of detections.

Clause 47. The non-transitory computer-readable medium of clause 46, further comprising computer-executable instructions that, when executed by the device, cause the device to: generate a first mapping of the assets to the attack paths; and generate a second mapping of the assets to the detections.

Clause 48. The non-transitory computer-readable medium of clause 47, wherein the computer-executable instructions that, when executed by the device, cause the device to perform the one or more remediation-related actions comprise computer-executable instructions that, when executed by the device, cause the device to: perform one or more selective remediations on one or more of the assets based on the first mapping and the second mapping.

Clause 49. The non-transitory computer-readable medium of any of clauses 38 to 48, wherein the computer-executable instructions that, when executed by the device, cause the device to perform the one or more remediation-related actions comprise computer-executable instructions that, when executed by the device, cause the device to: perform one or more remediations on the one or more critical assets before performing one or more remediations on one or more of the intermediate assets if the one or more critical assets and the one or more intermediate assets have a same asset remediation priority.

Clause 50. The non-transitory computer-readable medium of any of clauses 38 to 49, wherein the computer-executable instructions that, when executed by the device, cause the device to perform the one or more remediation-related actions comprise computer-executable instructions that, when executed by the device, cause the device to: perform a remediation on one of the assets selected for the remediation before performing a remediation on another one of the assets if one of the assets selected for the remediation has no compensating security control.

Clause 51. The non-transitory computer-readable medium of clause 50, wherein the compensating security control comprises: endpoint detection and response (EDR); antiviral software; local firewall; or any combination thereof.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line, or wireless technologies such as infrared, radio, and microwave, then the coaxial cable, fiber optic cable, twisted pair, digital subscriber line, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method, performed by a device, comprising:
determining a plurality of attack paths from a first set of assets to a second set of assets;
determining a plurality of asset remediation priorities based on an association between each of the assets and one or more of the attack paths; and
performing one or more remediation-related actions associated with one or more of the assets based on the asset remediation priorities.

2. The method of claim 1, wherein performing the one or more remediation-related actions comprises:
transmitting an asset remediation report.

3. The method of claim 1, wherein performing the one or more remediation-related actions comprises:
performing a selective remediation on at least one of the assets.

4. The method of claim 1, wherein the first set of assets includes a plurality of initial assets and a plurality of intermediate assets, and wherein the second set of assets includes one or more critical assets.

5. The method of claim 4, wherein determining the asset remediation priorities comprises:
assigning a first priority score to the one or more critical assets.

6. The method of claim 5, wherein determining the asset remediation priorities further comprises:
determining one or more attack path choke points among the intermediate assets based on a greatest number of attack path segments directly connected to each of the intermediate assets; and
assigning a second priority score to the one or more attack path choke points.

7. The method of claim 6, wherein determining the asset remediation priorities further comprises:
determining one or more distances based on a total number of the attack path segments from one or more of the assets in the first set to the one or more critical assets; and
assigning one or more third priority scores to one or more of the assets in the first set based on the one or more distances.

8. The method of claim 7, wherein determining the asset remediation priorities further comprises:
associating each asset in the first set with an asset criticality rating (ACR); and
assigning a fourth priority score to one or more of the assets in the first set based on the ACR.

9. The method of claim 8, wherein determining the asset remediation priorities further comprises:
assigning a fifth priority score to one or more of the assets on one or more of the attack paths other than the assets that are assigned the first, second, third or fourth priority scores.

10. The method of claim 9, wherein determining the asset remediation priorities further comprises:
assigning a sixth priority score to one or more of the assets that are not on any of the attack paths.

11. The method of claim 10, wherein performing the one or more remediation-related actions comprises:
performing one or more selective remediations on one or more of the assets based on one or more of the priority scores.

12. The method of claim 4, further comprising:
detecting a plurality of exposures by the assets to a plurality of vulnerabilities to obtain a plurality of detections.

13. The method of claim 12, further comprising:
generating a first mapping of the assets to the attack paths; and
generating a second mapping of the assets to the detections.

14. The method of claim 13, wherein performing the one or more remediation-related actions comprises:
performing one or more selective remediations on one or more of the assets based on the first mapping and the second mapping.

15. The method of claim 4, wherein performing the one or more remediation-related actions comprises:
performing one or more remediations on the one or more critical assets before performing one or more remediations on one or more of the intermediate assets if the one or more critical assets and the one or more intermediate assets have a same asset remediation priority.

16. The method of claim 4, wherein performing the one or more remediation-related actions comprises:
performing a remediation on one of the assets selected for the remediation before performing a remediation on another one of the assets if one of the assets selected for the remediation has no compensating security control.

17. The method of claim 16, wherein the compensating security control comprises:
endpoint detection and response (EDR);
antiviral software;
local firewall;
or any combination thereof.

18. A device, comprising:
one or more memories; and
one or more processors communicatively coupled to the one or more memories, the one or more processors, either alone or in combination, configured to:
determine a plurality of attack paths from a first set of assets to a second set of assets;
determine a plurality of asset remediation priorities based on an association between each of the assets and one or more of the attack paths; and
perform one or more remediation-related actions associated with one or more of the assets based on the asset remediation priorities.

19. The device of claim 18, wherein the one or more processors configured to perform the one or more remediation-related actions comprise the one or more processors, either alone or in combination, configured to:
transmit an asset remediation report.

20. The device of claim 18, wherein the one or more processors configured to perform the one or more remediation-related actions comprise the one or more processors, either alone or in combination, configured to:
perform a selective remediation on at least one of the assets.

21. The device of claim 18, wherein the first set of assets includes a plurality of initial assets and a plurality of intermediate assets, and wherein the second set of assets includes one or more critical assets.

22. The device of claim 21, wherein the one or more processors configured to determine the asset remediation priorities comprise the one or more processors, either alone or in combination, configured to:
assign a first priority score to the one or more critical assets.

23. The device of claim 22, wherein the one or more processors configured to determine the asset remediation priorities comprise the one or more processors, either alone or in combination, configured to:
determine one or more attack path choke points among the intermediate assets based on a greatest number of attack path segments directly connected to each of the intermediate assets; and
assign a second priority score to the one or more attack path choke points.

24. The device of claim 23, wherein the one or more processors configured to determine the asset remediation priorities comprise the one or more processors, either alone or in combination, configured to:
determine one or more distances based on a total number of the attack path segments from one or more of the assets in the first set to the one or more critical assets; and
assign one or more third priority scores to one or more of the assets in the first set based on the one or more distances.

25. The device of claim 24, wherein the one or more processors configured to determine the asset remediation priorities comprise the one or more processors, either alone or in combination, configured to:
associate each asset in the first set with an asset criticality rating (ACR); and
assign a fourth priority score to one or more of the assets in the first set based on the ACR.

26. The device of claim 25, wherein the one or more processors configured to determine the asset remediation priorities comprise the one or more processors, either alone or in combination, configured to:
assign a fifth priority score to one or more of the assets on one or more of the attack paths other than the assets that are assigned the first, second, third or fourth priority scores.

27. The device of claim 26, wherein the one or more processors configured to determine the asset remediation priorities comprise the one or more processors, either alone or in combination, configured to:
assign a sixth priority score to one or more of the assets that are not on any of the attack paths.

28. The device of claim 27, wherein the one or more processors configured to perform the one or more remediation-related actions comprise the one or more processors, either alone or in combination, configured to:
perform one or more selective remediations on one or more of the assets based on one or more of the priority scores.

29. The device of claim 21, wherein the one or more processors, either alone or in combination, are further configured to:
detect a plurality of exposures by the assets to a plurality of vulnerabilities to obtain a plurality of detections.

30. The device of claim 29, wherein the one or more processors, either alone or in combination, are further configured to:
generate a first mapping of the assets to the attack paths; and
generate a second mapping of the assets to the detections.

31. The device of claim 30, wherein the one or more processors configured to perform the one or more remediation-related actions comprise the one or more processors, either alone or in combination, configured to:
perform one or more selective remediations on one or more of the assets based on the first mapping and the second mapping.

32. The device of claim 21, wherein the one or more processors configured to perform the one or more remediation-related actions comprise the one or more processors, either alone or in combination, configured to:
perform one or more remediations on the one or more critical assets before performing one or more remediations on one or more of the intermediate assets if the one or more critical assets and the one or more intermediate assets have a same asset remediation priority.

33. The device of claim 21, wherein the one or more processors configured to perform the one or more remediation-related actions comprise the one or more processors, either alone or in combination, configured to:
perform a remediation on one of the assets selected for the remediation before performing a remediation on another one of the assets if one of the assets selected for the remediation has no compensating security control.

34. The device of claim 33, wherein the compensating security control comprises:
endpoint detection and response (EDR);
antiviral software;
local firewall;
or any combination thereof.

35. A non-transitory computer-readable medium storing computer-executable instructions that, when executed by a device, cause the device to:
determine a plurality of attack paths from a first set of assets to a second set of assets;
determine a plurality of asset remediation priorities based on an association between each of the assets and one or more of the attack paths; and
perform one or more remediation-related actions associated with one or more of the assets based on the asset remediation priorities.
